(19) United States
(12) Patent Application Publication
(10) Pub. No.: US 2023/0350969 A1
(43) Pub. Date: Nov. 2, 2023

(54) AUTOMATIC DISPLAY CONTROL METHOD FOR WEB CONTENT

(71) Applicant: PRIME STRATEGY CO., LTD., Tokyo (JP)

(72) Inventor: Kengyu NAKAMURA, Tokyo (JP)

(73) Assignee: PRINE STRATEGY CO., LTD., Tokyo (JP)

(21) Appl. No.: 17/783,322

(22) PCT Filed: May 20, 2020
(86) PCT No.: PCT/JP2020/020024

§ 371 Date: Jun. 8, 2022

(30) Foreign Application Priority Data
Dec. 13, 2019 (JP) 2019-225945

(51) Int. Cl. G06F 16/957; G06F 16/9535

(52) U.S. Cl. CPC G06F 16/9577; G06F 16/9535

(57) ABSTRACT

The present invention provides an automatic display control method for web content that promotes the common interests of a user who wants to view web content displayed on a web site in the shortest time and a web site operator who wants to provide information that the user is seeking in the shortest time. An automatic display control method for web content includes a step of calculating an engagement score between the user and the web content on the basis of the user experience of the user viewing the web content, a step of selecting data displayable on each user terminal from at least one of original data and a plurality of processed data according to the engagement score, and a step of displaying web content including the data selected in the selecting step on each user terminal from the first time.

### TECHNICAL FIELD

The present invention relates to an automatic display control method for web content, and more particularly, to an automatic display control method for web content based on engagement that maximizes the user experience.

### BACKGROUND ART

A user can use a user terminal such as a personal computer (PC), a smartphone, or a tablet to search for desired information whenever the user likes, and view web content displayed on the user terminal as a search result.

However, the information that the user wants to know is usually different for every user. Consequently, web site operators have a problem in deciding how to deliver web content to each user viewing the web site.

To address this problem, with regard to Internet advertisement display technology, for example, a technology related to a method of controlling the frequency and number of times an advertisement is displayed by using a revisit probability estimated from information such as user attributes has been proposed (Patent Literature 1). According to the above technology of the related art, information such as the attributes of each user can be utilized to deliver advertisements an appropriate number of times to each user.

In addition, a technology related to a score calculation method capable of calculating a score indicating user preferences by applying different weightings for each user attribute to an operation log with respect to web content has been proposed (Patent Literature 2). By obtaining a score indicating user preferences, it is possible to deliver content to each user on the basis of the score.

Also, in regard to product transactions performed on a web site, a technology related to a method of creating a recommendation list for recommending, to a user, appropriate cross-selling items to buy in combination with a main product has been proposed (Patent Literature 3). According to the above technology of the related art, a web search can be performed using product names listed in a recommendation list associated with a user's purchase history, product names having a number of search results equal to or less than a fixed ratio can be removed from the recommendation list, and products to recommend to the user can be narrowed down.

Also, a method of detecting the scroll speed of a user terminal of a user and preventing a delay in displaying data on the screen by not downloading data when the user is scrolling the screen at a certain speed or higher has been proposed (Patent Literature 4). By preventing content that the user does not want to be displayed from being downloaded, it is possible to keep the user terminal from slowing down under a heavy data load.

In addition, a technology related to a method of evaluating a degree of interest by an operator of a user terminal on the basis of the motion of a user terminal belonging to a cluster corresponding to a specific state and the motion of a user terminal belonging to a distracted state has been proposed (Patent Literature 5). According to the above technology of the related art, by measuring the motion of a user terminal, it is determined whether or not the operator of the user terminal is interested in particular web content.

On the other hand, according to the Akamai Image Manager technology provided by Akamai Technologies, Inc., individual images to be displayed on a web site can be provided automatically in an optimized combination of size, quality, and file format for a browser and a user terminal.

Also, a method referred to as a content delivery network (CDN) is commonly known as a method of causing data saved in a web server to be displayed on a user terminal of a user.

The operator of a web site can use a CDN method provided by a corporation by entering into a contract with the corporation that provides the CDN. In this case, a domain specified by the operator of the web site rather the domain of the corporation that provides the CDN can be used the domain of the web site published by an administrator. With this arrangement, the operator of the web site is able to provide a powerful CDN method to users while retaining the operator's own domain.

In the case of a CDN, a cluster of a plurality of web servers is prepared, and the same data is saved in each of the web servers. Thereafter, when the user uses the CDN method, data from the web server closest to the user terminal of the user is transmitted to the user terminal of the user.

If many user terminals access a single web server all at once, the load on the web server for processing requests is increased. Since there is a limit to the processing power per unit time of a web server, if accesses to a single web server become concentrated to a certain degree or more, the processing time by the web server tends to be delayed.

According to the CDN method, even if a single web server is accessed in a concentrated way by a large number of user terminals all at once, spare web servers can be recruited through a communication network established among the plurality of web servers in the cluster, thereby making it possible to accommodate a large number of data requests from the user terminals of users.

### CITATION LIST

### Patent Literature

Patent Literature 1: Japanese Translation of PCT International Application Publication No. 2007-508641
Patent Literature 2: Japanese Patent Laid-Open No. 2015-141530
Patent Literature 3: Japanese Patent Laid-Open No. 2012-203454
Patent Literature 4: Japanese Patent No. 5244911
Patent Literature 5: Japanese Patent Laid-Open No. 2019-128872

### SUMMARY OF INVENTION

### Technical Problem

In general, a user who views individual web pages included on a web site wants to view the information that he or she is seeking as quickly as possible.

On the other hand, the operator of the web site usually wants to provide the information that the user is seeking as quickly as possible.

If the operator of the web site is unable to provide the information that the user is seeking as quickly as possible, there is a high probability that the user will determine that the information he or she is seeking does not exist on the web site he or she is currently viewing.

Furthermore, the user who has determined that the information he or she is seeking does not exist will perform an action such as returning to a search screen and performing another search, or closing the browser for viewing web sites, otherwise referred to as “bounce”.

If the user bounce rate is high, the operator of the web site has fewer opportunities to show users the content the operator wants to provide to users, and therefore the operator of the web site needs to prevent this reduction of opportunity.

Also, the operator of a web site has web content that the operator wants users viewing the web site to, and wants users viewing the web site to perform certain actions.

Specifically, representative examples of the actions that the operator of a web site wants users viewing the web site to perform include actions such as a user purchasing a product listed on the web site, a user signing up for a service listed on the web site, or the user clicking on an advertisement button displayed on the web site, for example.

However, it is difficult for the operator of a web site to accurately grasp in advance what information users are seeking. One conceivable countermeasure is for the operator of a web site to include all web content that a user has a possibility of viewing.

However, preparing web content individually optimized for all users is difficult for the operator of a web site from both a technical standpoint and also a cost standpoint.

Furthermore, because the operator of a web site wants users to perform certain actions, all of the resources necessary to achieve the actions must be included in the system that displays the individual web pages.

The above resources include not only markup language such as HTML forming the web page and other code, programs such as CSS and JavaScript® included in the code, and data such as encoded images, but also external resources such as images, videos, JavaScript®, CSS, and web fonts called from within the code of the markup language such as HTML, and various resources called recursively from within the above resources.

For this reason, individual web pages typically include unoptimized resources, web content in consideration of possible actions that a user may take, and a large number of resources for actions that the site administrator wants users to perform, and such resources often include not only data such as images and videos, but also many programs such as JavaScript® to be executed on the side of the user terminal used by the user.

To display individual web pages on a user terminal used by a user, the user terminal used by the user needs to download large resources, which is time-consuming.

Also, in regard to the execution of programs in particular, operations such as downloading a program, analyzing the syntax, generating intermediate code, and executing is time-consuming compared to drawing other resources or the like.

For this reason, displaying individual web pages on a user terminal used by a user is highly time-consuming as a result. Moreover, it takes time until operations can be performed on individual web pages. The time taken by the above creates a situation in which the user experience with respect to a web site is not optimal.

According to the technologies of the related art described above, even if the operator of a web site is able to grasp a behavioral history and user attributes of individual users, such information is ordinarily from the past. Even a score indicating user preferences is information obtained on the basis of past actions by a user.

In the case of using statistical methods or the like to analyze a past behavioral history of users according to a method of the related art, the operator of a web site can grasp behavioral trends in users to some degree.

However, from the standpoint of an operator of a web site, even if it were possible to some degree to present information predicted to align with users' preferences from a past behavioral history of the users, the amount of information would become enormous over time.

Furthermore, the enormous amount of information would be merely a prediction, and it would be difficult to accurately grasp whether or not all of the enormous amount of information would be useful with respect to users.

It is not possible to clearly distinguish which portions of an enormous amount of accumulated information are useful with respect to users, and consequently, an enormous amount of information must be presented to the users. The above leads to a problem in that as time goes on, displaying enormous amounts of information on the information terminals of users becomes more time-consuming, creating a never-ending cycle. As enormous amounts of information are being stored over time, it is unclear how a past behavioral history of users can be used specifically to keep individual users from bouncing off a web site, even with reference to the related art cited above.

Also, with regard to a method of detecting the scroll speed of a user terminal of a user and preventing a delay in displaying data on the screen by not downloading data when the user is scrolling the screen at a certain speed or higher, it is presupposed that the user knows that the content displayed on the user terminal contains the information that the user is seeking, or in other words, that the user knows that he or she can reach the information he or she is seeking by scrolling.

There remains a problem in that if some data is not downloaded or displayed on the user terminal when the user views a web site for the first time, the user may have difficulty determining whether or not the web site he or she is viewing contains the desired content.

In addition, it is possible for the operator of a web site to learn to some degree whether a user is interested in the web content being displayed on a user terminal used by the user by using various sensors onboard the user terminal to track properties such as the motion and tilt of the user terminal.

However, in the case where the user terminal is simply placed on top of a table and not moving, for example, significant data cannot be measured from the motion of the user terminal.

As another example, in cases such as when the user is walking around while holding the user terminal, superfluous motion of the user terminal will be measured, making it difficult to accurately grasp whether the user is interested in the web content being displayed on the user terminal.

If individual images optimized for each browser and user terminal used by users and provided by a corporation such as Akamai Technologies, Inc. are used, images can be displayed quickly for each user.

According to this technology, the operator of a web site is able to present more data to users quickly.

A corporation learns which image a user is requesting only after a request is sent from the user to a server of the corporation. However, it is difficult to know in advance what kinds of images a user is going to request if the user has never transmitted a request to a server of the corporation until now.

For this reason, there remains a problem in that, although a corporation can provide images optimized for each browser and user terminal used by users when a user sends a request to a server of the corporation for the second time and thereafter, the corporation cannot provide optimized images in response to an initial request.

Hypothetically, if the CDN technology described above, the technology of the related art described above, and the technology for displaying images quickly to each user were combined, it would be possible to display images quickly for each user (assumed technology).

However, in this case, a problem would still remain in that, although individual images optimized for each browser and user terminal used by users can be provided when a user sends a request to a CDN web server cluster for the second time and thereafter, optimized images cannot be provided in response to an initial request.

Furthermore, if a problem occurs such that images are not displayed properly on the browser and user terminal of a portion of the users, it is necessary to transmit original data to the user terminal from a web server managed by the operator of the web server rather than from the CDN web server cluster.

In this case, even if the DNS is switched from the CDN web server cluster to the web server, the effects of the switch actually may take several hours to be reflected on the Internet, and in some cases may take 24 hours or more.

An objective of the present invention is to provide an automatic display control method for web content that resolves the conflicting intentions between a user who views web content displayed on a web site and an operator of the web site, and promotes the common interests of both parties.

### Solution to Problem

As a result of thorough investigation to address the above problem, the inventor discovered that an automatic display control method for web content including:
a step of generating a plurality of processed data by processing original data with which web content can be displayed on a user terminal;
a step of calculating an engagement score between a user and the web content on the basis of a user experience of the user viewing the web content; and
a step of selecting data displayable on each user terminal from at least one resource selected from the group consisting of the original data and the plurality of processed data according to the engagement score,
the above steps being performed at least one of before the web server receives a request from the user terminal and immediately after the web server receives the request from the user terminal; and
a step of displaying web content containing the data selected in the previous step for each user terminal from the first time
is suited to the objective of the present invention, and thereby completed the present invention.

Namely, the present invention provides
[1] An automatic display control method for web content in which data saved in a storage area usable by a web server is displayed on a user terminal over a network, the method including:
   a step of generating a plurality of processed data by processing original data saved in the storage area usable by the web server;
   a step of calculating an engagement score between a user and the web content on the basis of a user experience of the user viewing the web content; and
   a step of selecting optimized data displayable on each user terminal from at least one resource selected from the group consisting of the original data and the plurality of processed data according to the engagement score,
   the above steps being performed at least one of before the web server receives a request from the user terminal and immediately after the web server receives the request from the user terminal; and
   a step of displaying the web content to be displayed on each user terminal according to the generated optimized data from a first time that the request is transmitted from the user terminal to the web server.

Also, one aspect of the present invention provides
[2] The automatic display control method for web content according to [1] above, wherein
   the at least one resource selected from the group consisting of the original data and the plurality of processed data includes at least one of program data and binary data,
   the program data includes a program containing at least one selected from the group consisting of a markup language, a programming language, a style sheet, and a script language,
   the binary data includes at least one file selected from the group consisting of an image file, an audio file, and a video file, and
   the step of generating a plurality of processed data by processing original data saved in the storage area usable by the web server includes:
      a step of respectively specifying a program code portion to be executed and a program portion not to be executed from the program containing at least one selected from the group consisting of a markup language, a programming language, a style sheet, and a script language, and extracting a plurality of specified program code portions to be executed;
      a step of determining an execution order of the program code portions to be executed with priority and the program code portions to be executed with a delay among the plurality of specified program code portions to be executed;
      a step of determining an execution timing of the program code portions to be executed with priority and the program code portions to be executed with a delay among the plurality of specified program code portions to be executed; and
      a step of changing one selected from the group consisting of a number of display pixels per unit area, an image or sound recording density per unit time, a data size, and a save format of at least one file among the image file, the audio file, and the video file.

Also, one aspect of the present invention provides
[3] The automatic display control method for web content according to [1] or [2] above, wherein
   a user experience includes at least one type of request information selected from the group consisting of a number of times a request is transmitted from a browser installed in the user terminal to the web server, a type of request transmitted from the browser installed in the user terminal to the web server, a time the user stays on a web site, and a period between requests transmitted from the browser installed in the user terminal to the web server, and
   the engagement score is calculated on a basis of the request information including at least one selected from the group consisting of the number of times a request is transmitted from a browser installed in the user terminal to the web server, the type of request transmitted from the browser installed in the user terminal to the web server, the time the user stays on a web site, and the period between requests transmitted from the web server and the browser installed in the user terminal to the web server.

Also, one aspect of the present invention provides
[4] The automatic display control method for web content according to any of [1] to [3] above, wherein
   the step of selecting optimized data displayable on each user terminal from at least one resource selected from the group consisting of the original data and the plurality of processed data according to the engagement score includes:
      a step of selecting two or more of data displayable on each user terminal from among resources selected from the group consisting of the original data and the plurality of processed data according to the engagement score; and
      a step of comparatively ranking the two or more of the data on a basis of a display completion time for each user terminal.

Also, one aspect of the present invention provides
[5] The automatic display control method for web content according to any of [1] to [4] above, wherein
   the step of selecting optimized data displayable on each user terminal from at least one resource selected from the group consisting of the original data and the plurality of processed data according to the engagement score includes:
      a step of specifying, for each user terminal, a display environment of a display screen of the user terminal; and
      a step of specifying, for each user terminal, a portion of the web content that is displayed first to fit in the display environment of the display screen of the user terminal.

Also, one aspect of the present invention provides
[6] The automatic display control method for web content according to any of [1] to [5] above, further including:
   a step of comparing a state of original data saved in the storage area usable by the web server to a state of original data after a certain time elapses,
   and if an alteration consisting of at least one selected from the group consisting of an addition, a relocation, a removal, and a modification is detected with respect to the state of the original data after the certain time elapses,
   a step of generating a plurality of processed data by processing original data saved in the storage area usable by the web server.

Also, one aspect of the present invention provides
[7] The automatic display control method for web content according to any of [1] to [6] above, wherein
   the original data includes at least one of program data and binary data,
   the program data includes a program containing at least one selected from the group consisting of a markup language, a programming language, a style sheet, and a script language,
   the binary data includes at least one of an image file, an audio file, and a video file,
   the step of generating the processed data includes at least one step selected from the group consisting of the following (1) to (5), namely:
      (1) a step of removing an unnecessary portion for each user terminal display environment from at least one type of data selected from the group consisting of a program containing a markup language, a programming language, a style sheet, and a script language included in the original data;
      (2) a step of compressing a necessary portion for each user terminal display environment from at least one type of data selected from the group consisting of a program containing a markup language, a programming language, a style sheet, and a script language included in the original data;
      (3) a step of changing an execution order for each user terminal display environment from at least one type of data selected from the group consisting of a program containing a markup language, a programming language, a style sheet, and a script language included in the original data;
      (4) a step of changing an execution timing for each user terminal display environment from at least one type of data selected from the group consisting of a program containing a markup language, a programming language, a style sheet, and a script language included in the original data; and
      (5) a step of converting one selected from the group consisting of a number of display pixels per unit area, an image or sound recording density per unit time, a data size, and a save format from the binary data included in the original data; and
   the step of displaying the web content on the user terminal includes:
      a step of transmitting a request from a browser installed in the user terminal to the web server over a network;
      a step of the web server specifying a display environment for each user terminal from the request received by the web server; and
      a step of transmitting optimized data for displaying the web content from the web server to each user terminal and displaying the web content in the browser of the user terminal after the request is transmitted from the browser of the user terminal to the web server.

Also, one aspect of the present invention provides
[8] The automatic display control method for web content according to any of [1] to [7] above, wherein
   the step of generating the processed data is performed for each user terminal on a basis of a model information file storing data related to the display environment of the user terminal, the model information file being saved in a storage area usable by the web server,
   the above step being performed at least one of before the web server receives a request from the user terminal and immediately after the web server receives the request from the user terminal.

Also, one aspect of the present invention provides
[9] The automatic display control method for web content according to any of [1] to [8] above, wherein
   the step of displaying the web content on each user terminal includes:
      a step of transmitting, to the user terminal, a portion to be displayed first on a screen of the user terminal from among the optimized data for displaying the web content on the user terminal;
      a step of at least one of the web server and the browser detecting at least one of event information indicating that a certain time has elapsed since the optimized data corresponding to the portion displayed first on the screen of the user terminal was displayed on the user terminal, and event information indicating that a user has operated the user terminal to perform an action for causing additional information to be displayed on the user terminal; and
      a step of the web server transmitting some or all of the remaining portion of the optimized data to the user terminal over the network after at least one of the web server and the browser detects the event information.

Also, one aspect of the present invention provides
[10] The automatic display control method for web content according to any of [1] to [9] above, wherein
   the step of displaying the web content on each user terminal includes:
      a step of transmitting, to the user terminal, optimized data corresponding to a portion of the web content to be displayed first on a screen of the user terminal, wherein
   after the optimized data corresponding to the portion of the web content to be displayed first on the screen of the user terminal is transmitted to the user terminal, a time for prioritizing a process enabling the user terminal to accept input changes according to the engagement score.

Also, one aspect of the present invention provides
[11] The automatic display control method for web content according to any of [1] to [10] above, wherein
   the original data includes binary data, and the binary data includes at least one selected from the group consisting of an image file, an audio file, and a video file,
   a step of converting at least one selected from the group consisting of a number of display pixels per unit area, an image or sound recording density per unit time, a data size, and a save format from the binary data included in the original data,
   a step of generating a thumbnail image for display from at least one of the binary data included in the original data and the converted binary data, and
   a step of transmitting the thumbnail image for display instead of at least one of the binary data included in the original data and the converted binary data to the user terminal over the network and displaying the thumbnail image for display on the user terminal
   are performed before a request is transmitted from the browser installed in the user terminal to the web server, and
   a step of at least one of the web server and the browser detecting a signal indicating at least one of event information indicating that a certain time has elapsed since the data corresponding to the portion displayed first on the user terminal was displayed, and event information indicating that a user has operated the user terminal to perform an action for causing additional information to be displayed on the user terminal,
   a step of the web server transmitting at least one of the binary data included in the original data and the converted binary data to the user terminal over the network after at least one of the web server and the browser detects the signal, and
   a step of displaying at least one of the binary data included in the original data and the processed binary data on the user terminal instead of the thumbnail image for display
   are performed after the thumbnail image for display is displayed on the user terminal.

Also, one aspect of the present invention provides
[12] The automatic display control method for web content according to any of [1] to [11] above, wherein
   the step of generating a plurality of processed data by processing original data saved in the storage area usable by the web server includes:
   a step of prioritizing selection on a basis of data in a settings file saved in the storage area usable by the web server,
   the above step being performed at least one of before the web server receives a request from the user terminal and immediately after the web server receives the request from the user terminal.

Also, the present invention provides
[13] The automatic display control method for web content according to any of [1] to [12] above, wherein
   the step of selecting optimized data displayable on each user terminal from at least one resource selected from the group consisting of the original data and the plurality of processed data according to the engagement score includes:
      a step of changing an execution order of programs respectively corresponding to
         a data portion of the web content displayed first on a screen of the user terminal,
         a time until the user terminal accepts input with respect to the portion of the web content displayed first on the screen of the user terminal, and
         a data portion other than the data portion of the web content displayed first on the screen of the user terminal
      and also, a step of changing an execution timing of programs respectively corresponding to
         a data portion of the web content displayed first on a screen of the user terminal,
         a time until the user terminal accepts input with respect to the portion of the web content displayed first on the screen of the user terminal, and
         a data portion other than the data portion of the web content displayed first on the screen of the user terminal
      with respect to data for displaying web content selected for each user terminal from among data for displaying a plurality of pieces of web content with different display completion times with respect to the user terminal, and recording a change in the engagement score at regular intervals; and
      a step of learning which combinations of original data and the plurality of processed data forming the web content maximize the time spent viewing the web content by all users and the number of actions performed on the web content by all users from among the plurality of pieces of web content with different display completion times with respect to the user terminal.

Also, the present invention provides
[14] A program for performing the automatic display control method for web content according to any of [1] to [13] above, including:
   a means of generating a plurality of processed data by processing original data saved in the storage area usable by the web server;
   a means of calculating an engagement score between a user and the web content on the basis of a user experience of the user viewing the web content; and
   a means of selecting optimized data displayable on each user terminal from at least one resource selected from the group consisting of the original data and the plurality of processed data according to the engagement score, wherein
   the automatic display control program for web content includes
   a means of displaying the web content to be displayed on each user terminal according to the generated optimized data from a first time that the request is transmitted from the user terminal to the web server.

Also, one aspect of the present invention provides
[15] A storage device storing the automatic display control program for web content according to [14] above.

Also, the present invention provides
[16] A system for performing the automatic display control method for web content according to any of [1] to [13] above, including:
   a means of generating a plurality of processed data by processing original data saved in the storage area usable by the web server;
   a means of calculating an engagement score between a user and the web content on the basis of a user experience of the user viewing the web content; and
   a means of selecting optimized data displayable on each user terminal from at least one resource selected from the group consisting of the original data and the plurality of processed data according to the engagement score, wherein
   the automatic display control system for web content includes
   a means of displaying the web content to be displayed on each user terminal according to the generated optimized data from a first time that the request is transmitted from the user terminal to the web server.

### Advantageous Effects of Invention

According to the automatic display control method for web content according to the present invention, in the case where a score indicating a value of engagement based on the user experience is low, a minimum necessary amount of web content with a short display completion time for display on a user terminal of a user can be transmitted from a web server and displayed on the user terminal in a short time.

Also, after the web content with a short display completion time is transmitted from the web server, a step enabling the user terminal to accept input can be prioritized appropriately. Thereafter, web content is transmitted to the user terminal to enable the user to view content such as advertisements that take time to display and video content that takes time until the video is ready for playback, for example.

With this arrangement, the display completion time of the web content can be shortened, making it possible to prevent a user with a low engagement score from bouncing off the web site even in cases where sufficient engagement has not been established between the user and the operator of the web site.

Conversely, in the case of a high engagement score based on the user experience, sufficient engagement has been established between the user and the operator of the web site. For this reason, the user is expected to show sufficient interest in the web content to be displayed on the user terminal.

In this case, even if web content is transmitted to enable the user to view content such as advertisements that take time to display and video content that takes time until the video is ready for playback without prioritizing the step of enabling the user terminal to accept input, for example, the probability that the user will bounce is expected to be low because a trust relationship has been nurtured between the user and the operator of the web site.

Moreover, the preparations for displaying web content that takes time to prepare, such as video playback, are completed at an earlier stage for users with a high engagement score, and consequently user satisfaction can be raised further.

In this way, according to the present invention, resources and programs forming web content can be delivered to each user quickly from the first time onward according to the level of engagement by the user, thereby balancing the interests of users and site operators.

As a result of balancing these interests, it is possible to provide an automatic display control method for web content that resolves the conflicting intentions between a user who views web content displayed on a web site and an operator of the web site, and promotes the common interests of both parties.

### BRIEF DESCRIPTION OF DRAWINGS

FIG. 1 is a schematic diagram illustrating a configuration of an automatic display control system for carrying out an automatic display control method for web content according to Embodiment 1 of the present invention.

FIG. 2 is a diagram for explaining a hardware configuration of a user terminal used in the automatic display control method for web content according to Embodiment 1 of the present invention.

FIG. 3 is a diagram for explaining a hardware configuration of a web server used in the automatic display control method for web content according to Embodiment 1 of the present invention.

FIG. 4 is a diagram for explaining details of a hardware configuration included in a storage device 1101 of a web server 103 used in the automatic display control method for web content according to Embodiment 1 of the present invention.

FIG. 5 is a schematic diagram for explaining relationships among files saved in an original data storage area and a processed data storage area of a storage device used in Embodiment 1 of the present invention.

FIG. 6 is a flowchart for explaining the relationship between processed data generation and resource optimization.

FIG. 7 is a schematic diagram for explaining a settings file 125 and a model information file 126 saved in a settings file storage unit 123 of the storage device 1101 of the web server 103.

FIG. 8 is a diagram illustrating one example of the model information file 126 saved in the settings file storage unit 123 of the storage device 1101 of the web server 103 used in a first embodiment of the present invention.

FIG. 9 is a conceptual diagram for explaining a correspondence relationship between an unprocessed HTML file and a processed HTML file.

FIG. 10 is a flowchart for explaining a step in which unnecessary portions are removed for each user terminal display environment.

FIG. 11 is a flowchart for explaining a step in which necessary portions are compressed for each user terminal display environment.

FIG. 12 is a diagram for explaining a step in which script language file portions 108a to 108d written in an HTML file 113 are executed serially.

FIG. 13 is a diagram for explaining a step in which the script language file portions 108a to 108c are executed in parallel with the script language file 108d written in the HTML file 113.

FIG. 14 is a diagram for explaining a step in which the execution of the script language file 108d written in the HTML file 113 is deferred.

FIG. 15 is a flowchart for explaining a step in which processed data is generated.

FIG. 16 is a flowchart for explaining a step in which a signal indicating that original data 200 has been altered is transmitted to an operation control unit.

FIG. 17 is a flowchart for explaining a step in which processed data is newly generated according to the signal indicating alteration of the original data 200.

FIG. 18 is a flowchart for explaining a step of specifying minimized data displayable in a display environment of a user terminal 101.

FIG. 19 is a diagram for explaining a step of learning how to select web content according to an engagement score.

FIG. 20 is a conceptual diagram for explaining a mechanism by which web content 211 is displayed quickly on the user terminal 101.

FIG. 21 is a schematic diagram for explaining a display and a change of thumbnail images on an initial display screen of a user terminal.

### DESCRIPTION OF EMBODIMENTS

First, the user experience and engagement used in the disclosure of the present invention will be described.

The “user experience” used in the disclosure of the present invention means what the user experiences when viewing web content displayed on a user terminal.

Specifically, for example, the user experience is one or more actions such as the user reading text information displayed in the web content, scrolling a browser installed in the user terminal to continue reading the text information further, clicking on a link associated with the web content to view the content at the link destination, playing back a video file, playing back a music file, or viewing an image file associated with the web content, inputting text information into a form field and transmitting the text information, and purchasing a product displayed in the web content.

Actual individual user experiences can be captured by the browser installed in the user terminal.

In the case where the user viewing the web content determines that he or she is not interested in the web content, or that the web content does not contain information that the user is seeking, the user performs an action referred to as bouncing.

If a user does not view the web content, a score related to the user experience for that user is zero.

If a user does not view web content again, the score related to the user experience is not increased.

After a request is transmitted to a web server from the browser installed in the user terminal, it takes time until a web page from among one or a plurality of web pages included in the web content of the web site is displayed on the browser installed in the user terminal and the web page begins to accept input from the user (designated the “display completion time” in the disclosure of the present invention), and the amount of time that users are willing to tolerate is said to be two seconds or less.

How long of a display completion time may be tolerated depends on the user's engagement with the web site.

If the user trusts the web site and is confident that the web site contains needed information, the user is willing to tolerate a longer display completion time. In the opposite case, the user is unwilling to wait for even a second.

Conversely, the user experience increases in the case where the user does not bounce but instead performs an action such as continuing to read the web content displayed on the user terminal of the user.

Additionally, if the user executes all actions associated with the web content provided by the provider of the web content and the administrator of the web site displayed on the user terminal of the user, the user experience for the user at that point in time is maximized.

In the case where the user experience is maximized for a specified user, a score associated with the user experience may be set to a relative value of 100.

Also, the “engagement” used in the disclosure of the present invention means a trust relationship nurtured through web content between the user viewing the web content displayed on the user terminal and the operator of a web site.

In the disclosure of the present invention, this trust relationship is treated as being related to the user experience.

In other words, in the case where there is no engagement between the user and the operator of the web site, for example, the engagement corresponds to a relative value of 0 when the user is not viewing the web content.

However, after a request is transmitted from a user terminal 101 to a web server 103 even once, the user experience of the user accessing the web content is increased as an engagement score. For this reason, if a history of the user terminal 101 accessing the web server 103 is saved, the engagement score related to the user terminal 101 is recorded as a value greater than zero.

On the other hand, in the case where the user experience is maximized for a certain user, a sufficient trust relationship is considered to be nurtured between the user and the operator of the web site, and therefore the engagement corresponds to a relative value of 100.

In other words, the value of the engagement based on the user experience for each user varies as a relative value from 0 to 100.

According to the findings from previous studies by the inventor, the value of the engagement tends to decrease for users with no interest in web content, whereas the value of the engagement tends to increase for users who express interest in web content.

The disclosure of the present invention discloses a method that adjusts the process of displaying web content displayed on user terminals viewed by respective users according to the engagement score of each user, and thereby maximizes the interests of the users viewing the web site and the administrator of the web site.

Hereinafter, embodiments of the present invention will be described with reference to the drawings, but the present invention is not limited to the following embodiments.

### Embodiment 1

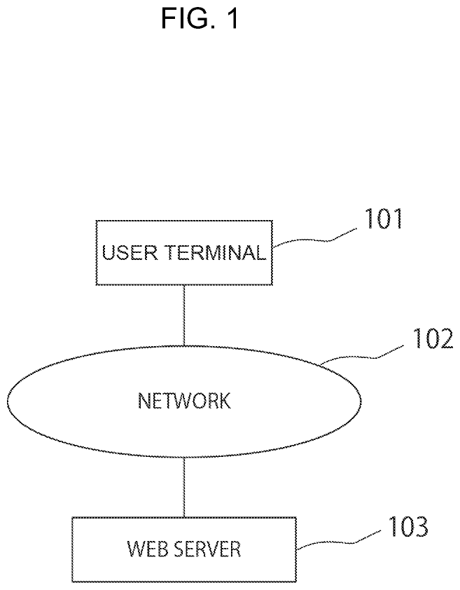

FIG. 1 is a schematic diagram illustrating a configuration of an automatic display control system for carrying out an automatic display control method for web content according to Embodiment 1 of the present invention.

In FIG. 1, a user terminal 101 and a web server 103 that manages data such as a web site are connected over a network 102 by a wired or wireless connection.

Specific examples of the user terminal 101 include a mobile information terminal such as a smartphone or a feature phone, an information display terminal such as a personal digital assistant (PDA) or a tablet, a wearable communication terminal such as a smartwatch or smart glasses, and a computer such as a personal computer (PC).

In FIG. 1, a single user terminal 101 is illustrated as an example, but in actuality, one or more user terminals 101 may be used.

Examples of the network 102 used in Embodiment 1 of the present invention include one or more from among a virtual private network (VPN), a local area network (LAN), a wide area network (WAN), the public switched telephone network (PSTN), the Internet, an intranet, Ethernet®, a mobile phone network, or a public switched telephone network, for example.

The network 102 is capable of providing interconnections through a wired medium using optical fiber, communication wire, or the like, or through a wireless medium using electromagnetic waves such as infrared rays or radio waves.

The web server 103 includes a function of providing the user terminal 101 with information such as a web site including text data, such as letters, symbols, and numerals in various languages, and binary data such as images, video, and audio.

The web server 103 is not limited in type, functions, or the like insofar as the web server 103 can be used to achieve the embodiments described hereinafter.

[Hardware Configuration of Each Device Used in Automatic Display Control Method for Web Content]

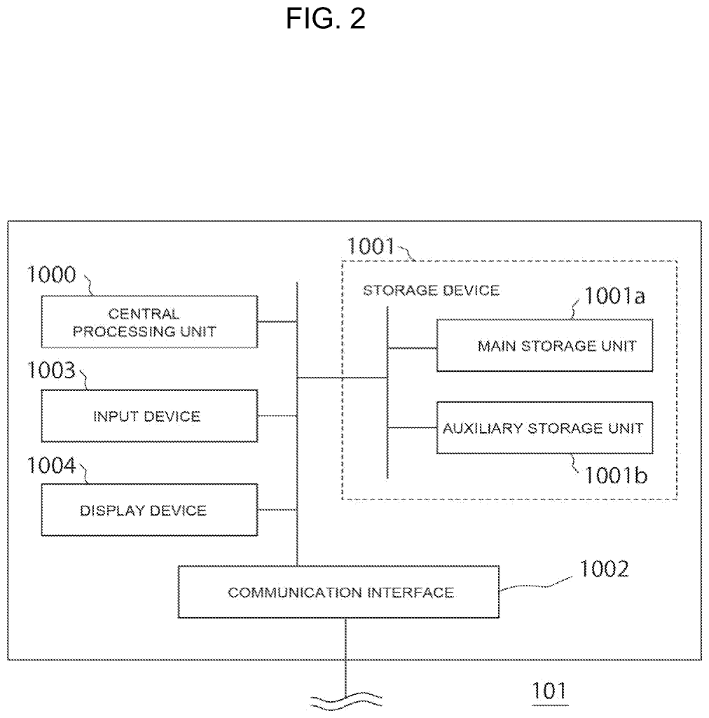

FIG. 2 is a diagram for explaining a hardware configuration of a user terminal used in the automatic display control method for web content according to Embodiment 1 of the present invention.

First, the hardware configuration of the user terminal 101 will be described.

For example, the user terminal 101 is provided with a hardware configuration including components such as a central processing unit (CPU) 1000, a storage device 1001, a communication interface 1002, an input device 1003, and a display device 1004. These hardware components are interconnected and are capable of communicating with each other.

The central processing unit 1000 includes a circuit capable of executing content stated in a program and thereby execute various processes.

The configuration of the central processing unit 1000 is not limited to being provided with a single microprocessor, and may also have a multi-processor configuration provided with two or more processors.

The storage device 1001 can store information such as data and programs necessary for operations by the user terminal 101. The storage device 1001 includes a main storage unit 1001a and an auxiliary storage unit 1001b.

For example, a browser that acts as a program application for viewing web content on the user terminal 101 is saved in the storage device 1001. The browser can be used to display web content on the user terminal 101 using information such as data downloaded from the web server 103 to the user terminal 101.

For the main storage unit, volatile memory such as random access memory (RAM) is used, for example. For the auxiliary storage unit, non-volatile memory such as a hard disk, a solid-state disk, or flash memory is used, for example.

The communication interface 1002 receives various data transmitted from the web server 103 over the network 102, and transfers various data to the central processing unit 1000.

Additionally, the communication interface 1002 transmits various data from the user terminal 101 to the web server 103 over the network 102.

The input device 1003 is a device used to perform various input operations on the user terminal 101. A device integrated with the display device 1004 may be used as the input device 1003, or separate devices for the input device 1003 and the display device 1004 may be used.

The input device 1003 can accept the input of various data from the user. The accepted various types of data are transferred to the central processing unit 1000.

Examples of the input device 1003 include a touch panel, a touchpad, a mouse, a keyboard, a camera, or a microphone.

For example, in the case of a touch panel or a touchpad, the input of various data is accepted according to operations performed by the user's finger, operations performed using a dedicated input tool such as a touch pen, or the like.

In the case of a mouse, the input of various data is accepted according to operations such as moving the mouse, pressing left or right keys installed on the mouse, clicking a certain number of times, tapping, or dragging.

In the case of a keyboard, the input of various data is accepted according to operations such as pressing any of various keys installed on the keyboard and pressing various keys at the same time.

In the case of a camera, the input of various data is accepted by analyzing an image captured by the camera and converting the image into a signal that can be transferred to the central processing unit 1000.

In the case of a microphone, the input of various data is accepted by analyzing sound captured by the microphone and converting the sound into a signal that can be transferred to the central processing unit 1000.

The display device 1004 can display various data processed by the central processing unit 1000.

The display device 1004 may be a liquid crystal panel, an organic EL panel, a liquid crystal monitor, or an organic EL monitor, for example. The display 1004 may also be a touch panel that accepts the input of various data.

Next, a hardware configuration of the web server 103 will be described.

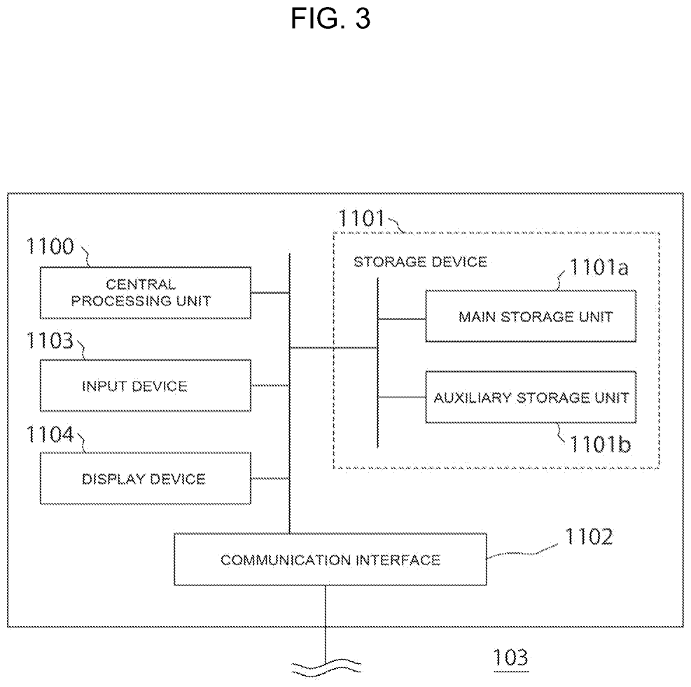

FIG. 3 is a diagram for explaining a hardware configuration of a web server used in the automatic display control method for web content according to Embodiment 1 of the present invention.

For example, the web server 103 is provided with a hardware configuration including components such as a central processing unit (CPU) 1100, a storage device 1101, a communication interface 1102, an input device 1103, and a display device 1104. These hardware components are interconnected and are capable of communicating with each other.

The web server 103 used in the disclosure of the present invention may use one or more types of execution environments for each of a physical machine, a virtual machine, a container, or the like. Moreover, a combination of one or more types of one or a plurality of each of a physical machine, a virtual machine, a container, or the like may be used to construct an execution environment.

Also, the web server 103 may connect to one or more external web servers different from the web server 103 over the network 102 to process data cooperatively.

The central processing unit 1100 includes a circuit capable of executing content stated in a program saved in a storage area of the storage device 1101, and thereby execute various processes.

The configuration of the central processing unit 1100 is not limited to being provided with a single microprocessor, and may also have a multi-processor configuration provided with two or more processors.

The storage device 1101 can store information such as data and programs necessary for operations by the web server 103. The storage device 1101 includes a main storage unit 1101a and an auxiliary storage unit 1101b.

For the main storage unit, volatile memory such as random access memory (RAM) is used, for example. For the auxiliary storage unit, non-volatile memory such as a hard disk, a solid-state disk, or flash memory is used, for example.

In FIG. 3, the storage device 1101 is installed inside the web server 103. The web server 103 may use data saved in a storage area of the storage device 1101.

In addition, the storage device 1101 may also be installed outside the web server 103. Through the communication interface 1102 provided in the web server 103, the web server 103 can also use data saved in a storage area of the storage device 1101 over the network 102.

The communication interface 1102 receives various data transmitted from the user terminal 101 over the network 102, and transfers various data to the central processing unit 1100.

Additionally, the communication interface 1102 transmits various data from the web server 103 to the user terminal 101 over the network 102.

The input device 1103 is a device used to perform various input operations on the web server 103. A device integrated with the display device 1104 may be used as the input device 1103, or separate devices for the input device 1103 and the display device 1104 may be used.

The input device 1103 can accept the input of various types of data from a web server administrator. The accepted various types of data are transferred to the central processing unit 1100.

Examples of the input device 1103 include a touch panel, a touchpad, a mouse, a keyboard, a camera, or a microphone.

The display device 1104 can display various data processed by the central processing unit 1100.

The display device 1104 may be a liquid crystal panel, an organic EL panel, a liquid crystal monitor, or an organic EL monitor, for example. The display device 1104 may also be a touch panel that accepts the input of various data.

When operating the web server 103, for example, the administrator of the web server 103 inputs data such as letters, numerals, and symbols using the input device 1103 such as a command line interface (CLI) 203 displayed on the display device 1104.

[Details of Hardware Configuration Included in Storage Device 1101]

Next, the details of the hardware configuration included in the storage device 1101 of the web server 103 will be described.

Note that the hardware configuration used in the disclosure of the present invention may use one or more types of execution environments for each of a physical machine, a virtual machine, a container, or the like. Moreover, a combination of one or more types of one or a plurality of each of a physical machine, a virtual machine, a container, or the like may be used to construct an execution environment.

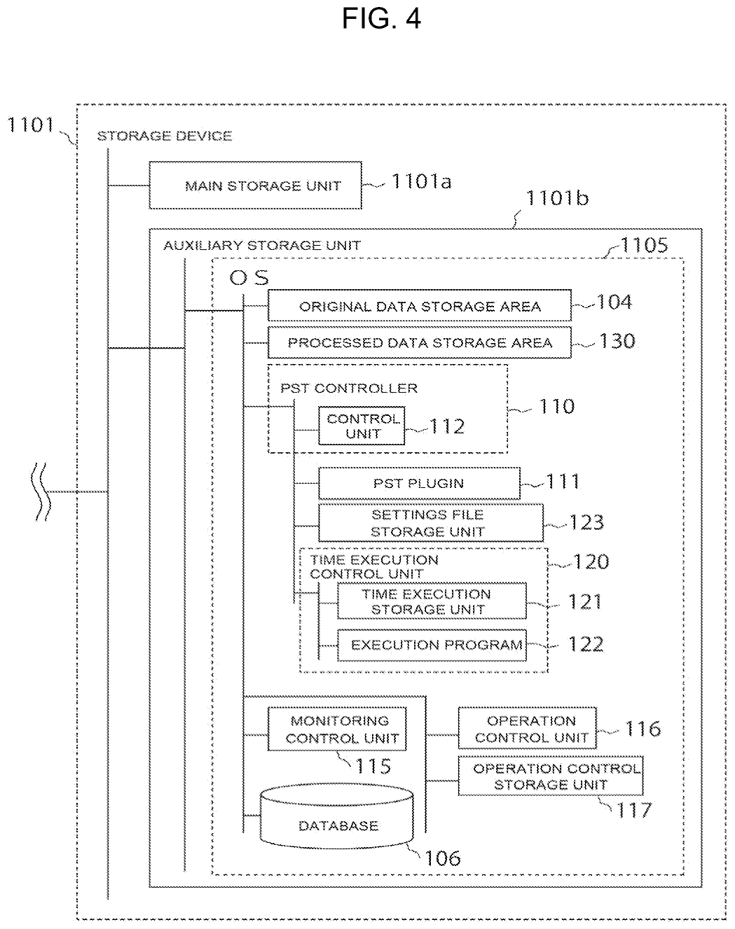

FIG. 4 is a diagram for explaining details of a hardware configuration included in the storage device 1101 of the web server 103 used in the automatic display control method for web content according to Embodiment 1 of the present invention.

For example, an operating system (OS) 1105 is installed in the storage device 1101 and is capable of controlling the central processing unit 1100, the storage areas and programs in the storage device 1101, and the like.

The OS 1105 may be obtained from the market for a fee or free of charge.

In Embodiment 1 of the present invention, the automatic display control method for web content according to Embodiment 1 of the invention is achieved by causing the central processing unit 1100 to run programs in an execution environment where the OS 1105 or the like is installed.

In FIG. 4, the storage device 1101 is provided with an original data storage area 104 and a database 106. Original data 200 for displaying web content on the user terminal 101 of a user is saved in the original data storage area 104.

The storage device 1101 is also provided with components such as a page speed technology (PST) controller 110, a page speed technology (PST) plugin 111, and a settings file storage unit 123.

The web server 103 and the PST plugin 111 are controlled by a program written in a control unit 112 of the PST controller 110.

The PST controller 110 may function as a web worker, for example. The control unit 112 of the PST controller 110 is capable of executing the processes of various programs in the background independently, without being affected by the execution of programs by the web server 103.

The PST controller 110 may be divided into a component that controls individual web sites and a component that controls the web server 103, for example.

If the PST controller 110 is managed by being divided up for individual web sites, for each web site, an administrator of the web site may check the content visually through a CLI or the like, and add or change various settings depending on the actual state of each web site.

As another example, if the PST controller 110 that controls the web server 103 is prepared separately from the component for individual web sites, an administrator of the web server 103 may check the content visually through a CLI or the like for overall settings shared by all of the web sites, and add or change various settings for the web server 103.

To accommodate various types of web servers 103, data necessary for the control unit 112 of the PST controller 110 to operate on the basis of information related to properties such as the type of OS 1105 and the running environment is saved in the PST plugin 111.

In addition, the storage device 1101 is provided with a monitoring control unit 115, an operation control unit 116, and an operation control storage unit 117.

The monitoring control unit 115 monitors the original data 200 and can detect if there is an alteration such as an addition, relocation, removal, or modification of any data such as a PHP file 105, an HTML file 113, a CSS file 107, a script language file 108, or an image file 109 included in the original data 200, for example.

The storage device 1101 is provided with a time execution control unit 120.

The time execution control unit 120 can obtain an accurate current time over the network 102. An execution program 122 containing information indicating what is to be executed when and at what timing is saved in a time execution storage unit 121 of the time execution control unit 120.

[Original Data 200 Used in Automatic Display Control Method for Web Content]

Next, the original data 200 used in the automatic display control method for web content according to Embodiment 1 of the present invention will be described.

Examples of the original data 200 include one or more from among program data including: a markup language such as HTML or XML, a programming language such as PHP, Perl, Java®, C, C++, or Lua, a style sheet such as CSS or SCSS, a script language such as JavaScript®, TypeScript®, or the JavaScript® library jQuery®, or the like; or binary data such as image files, audio files, or video files.

The markup language may contain text data such as numeral data, symbol data, and letter data.

The original data 200 includes at least one resource selected from the group consisting of program data or binary data, the program data including a markup language, a programming language, a style sheet, a script language, or the like.

The markup language such as HTML or XML is a program that determines the basic layout of the web site or the like.

The programming language such as PHP, Perl, Java®, C, C++, or Lua is a program that actually runs on a machine such as the web server 103 or the user terminal 101.

The style sheet such as CSS or SCSS is a program that controls design elements such as the position, size, and type of letters, numerals, symbols, images, and the like that are displayed on the web site or the like.

Also, the script language such as JavaScript®, TypeScript®, or the JavaScript® library jQuery® is a program that performs a variety of processes necessary to display web content on the user terminal 101, mainly processes enabling the user to perform operations such as clicking buttons or the like and scrolling a web site or the like displayed on the user terminal.

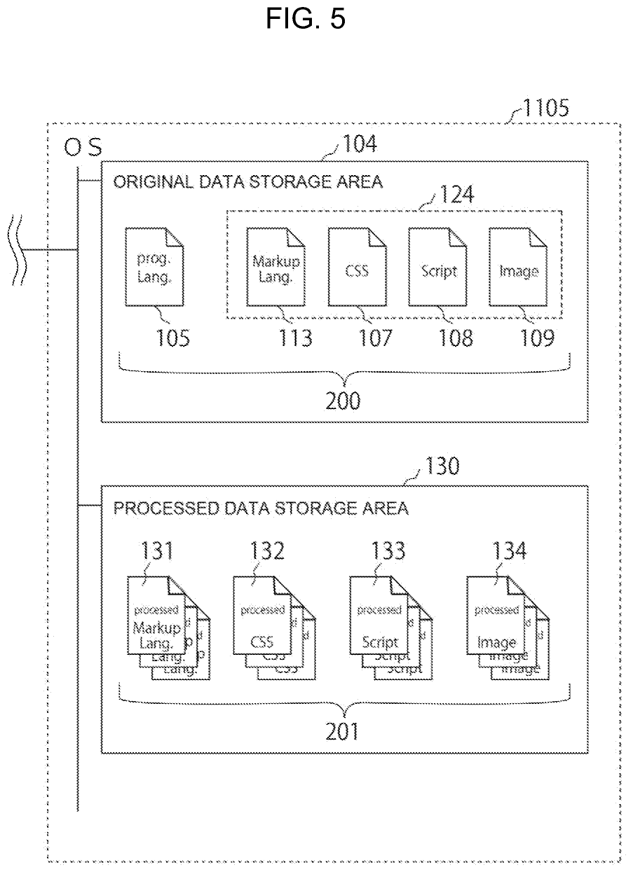

FIG. 5 is a schematic diagram for explaining relationships among files saved in an original data storage area and a processed data storage area of a storage device used in Embodiment 1 of the present invention.

The reference signs in FIG. 5 are the same as in FIG. 4, and the relationships between the original data storage area 104 and the processed data storage area 130 respectively illustrated in FIGS. 4 and 5 are the same.

Note that the descriptions of the files in the disclosure of the present invention are illustrative examples, and mean that data can be managed in a file format. By managing the data in a file format, the data can be managed visually by people through a CLI or the like.

FIG. 5 schematically illustrates how data can be managed in a file format.

For instance, as one specific example in FIG. 5, program data written in the PHP programming language is saved in the original data storage area 104 as a PHP file 105. Also, data necessary for displaying the PHP file 105 is stored in the database 106.

In the case of Embodiment 1 according to the present invention, the PHP file 105 is used as the program data, but the program data used in the present invention is not limited to PHP, and any program data may be selected appropriately and used insofar as web content can be displayed.

As another example, a CSS file 107, a script language file 108, and an image file 109 are saved in the original data storage area 104 as resource files 124.

Data necessary for displaying a web site or the like is referenced from the database 106 by the program written in the PHP file 105 or the like as the program data.

In addition, reference information to the CSS file 107, the script language file 108, and the image file 109 is written in the PHP file 105 or the like, and web content to be displayed on the user terminal 101 can be generated from the PHP file 105 or the like using the CSS file 107, the script language file 108, and the image file 109.

Objects defined inside the PHP file 105 or the like are saved in the database 106.

The database 106 is provided with a data reading means, a data writing means, a data saving means, and a data searching means, for example.

Data corresponding to variables written in the PHP file 105 or the like are written to and saved in the database 106 in advance.

Additionally, data saved in the database 106 can be called on the basis of the variables or the like written in the PHP file 105 or the like.

Under control by the control unit 112 of the PST controller 110 illustrated in FIG. 4, the web server 103 executes the program written in the PHP file 105 or the like, and an HTML file 113 is generated.

The HTML file 113 may be pregenerated statically or may be generated dynamically every time the program written in the PHP file 105 or the like is executed before or immediately after a request from the user terminal 101.

Ordinarily, the HTML file 113 is generated dynamically. The same applies hereinafter.

Under control by the control unit 112 of the PST controller 110 illustrated in FIG. 4, the CSS file 107 and the script language file 108 likewise may be pregenerated statically or may be generated dynamically every time the program written in the PHP file 105 is executed before or immediately after a request from the user terminal 101. The same applies hereinafter.

In the disclosure of the present invention, the web server 103 may also dynamically execute the program written in the PHP file 105 or the like in response to a request by the user from the user terminal 101, transmit the generated display content from the web server 103 to the user terminal 101, and dynamically display web content on the user terminal 101 side.

The HTML file 113 may also be generated in advance by the control unit 112 of the PST controller 110 before the web server 103 receives a request by the user from the user terminal 101. With this arrangement, the web content does not have to be generated dynamically every time a request by the user is received from the user terminal 101, and the display completion time of the web content can be shortened.

For example, a portion referencing the CSS file 107, the script language file 108, and the image file 109 for displaying web content on the user terminal 101 is written in the HTML file 113.

For example, under control by the control unit 112 of the PST controller 110, when the web server 103 executes the program written in the HTML file 113, a program written in each of the CSS file 107 and the script language file 108 are also executed in accordance with the execution of the program.

Web content can be generated in accordance with the execution of the program written in the HTML file 113.

Ordinarily, for example, the HTML file 113 is downloaded to the user terminal 101 and executed by a browser or the like installed in the user terminal 101. Thereafter, web content is displayed on the user terminal 101.

For web content including information such as text information and program data written in the PHP file 105, the HTML file 113, or the like and image information from the image file 109, properties such as the display position, the display size, and the display layout are specified by the CSS file 107 and the script language file 108 according to the display environment of the user terminal 101.

For example, the original data 200 including the HTML file 113, the CSS file 107, the script language file 108, the image file 109, and the like is ordinarily created so as to be displayable without alteration according to the display environments of all user terminals 101 anticipated to access the web server 103.

The original data 200 includes at least one of program data and binary data.

With the original data 200 including the PHP file 105, the HTML file 113, the CSS file 107, the script language file 108, and the image file 109 used in Embodiment 1 according to the present invention illustrated by way of example in FIG. 5, web content can be displayed with respect to the display environments of all kinds of user terminals 101 anticipated to access the web server 103, but on the other hand, the original data 200 also includes portions that are not needed in the display environments of individual user terminals 101.

For example, the original data 200 necessary in the case where the user terminal 101 is a PC also includes portions of the original data 200 that are not necessary in the case where the user terminal 101 is a smartphone.

Conversely, the original data 200 necessary in the case where the user terminal 101 is a smartphone also includes portions of the original data 200 that are not necessary in the case where the user terminal 101 is a PC.

In addition, in some cases, even in the case where the user terminal 101 is a smartphone, the necessary portions of the original data 200 may be different among a plurality of different smartphones, for example.

Furthermore, in some cases, the necessary portions of the original data 200 may be different depending on the type of browser installed in the user terminal 101, for example.

If the same original data 200 is transmitted indiscriminately from the web server 103 to each of the user terminals 101, the result is that the original data 200 will include data that does not need to be displayed on the individual user terminals 101.

To prevent data that does not need to be displayed on the individual user terminals 101 from being transmitted from the web server 103 to the individual user terminals 101 and shorten the display completion time, the original data 200 is processed, and a plurality of processed data 201 is generated.

The original data 200 includes program data.

Also, the program data includes programs and the like, including information such as a markup language, a programming language, a style sheet, and a script language.

Reference information to information such as an external style sheet, an external script language, or external binary data is also included in the markup language.

Note that the term “external” here means, for example, information which is not written directly in the markup language or the like, but which can be utilized as web content by being referenced from within the markup language or the like.

For example, the HTML file 113, which is one program including a markup language, includes a plurality of code portions of the HTML file written directly in the HTML file 113, a plurality of code portions in the CSS file 107, a plurality of code portions in the script language file 108, and the like. In addition, the HTML file 113 includes file portions of a plurality of referenced CSS files 107, file portions of a plurality of script language files 108, and the like.

Reference portions related to one or more types of files such as image files, audio files, and video files are also written in the HTML file 113.

The HTML file 113 and the like are downloaded from the web server 103 to the user terminal 101 over the network 102 according to a program written in the control unit 112 of the PST controller 110.

As described above, if the HTML file 113 and the like are executed by the browser installed in the user terminal 101, web content 211 based on the original data 200 is displayed on each user terminal 101.

Next, to illustrate an overview of Embodiment 1 according to the present invention, processed data generation and resource optimization will be summarized first.

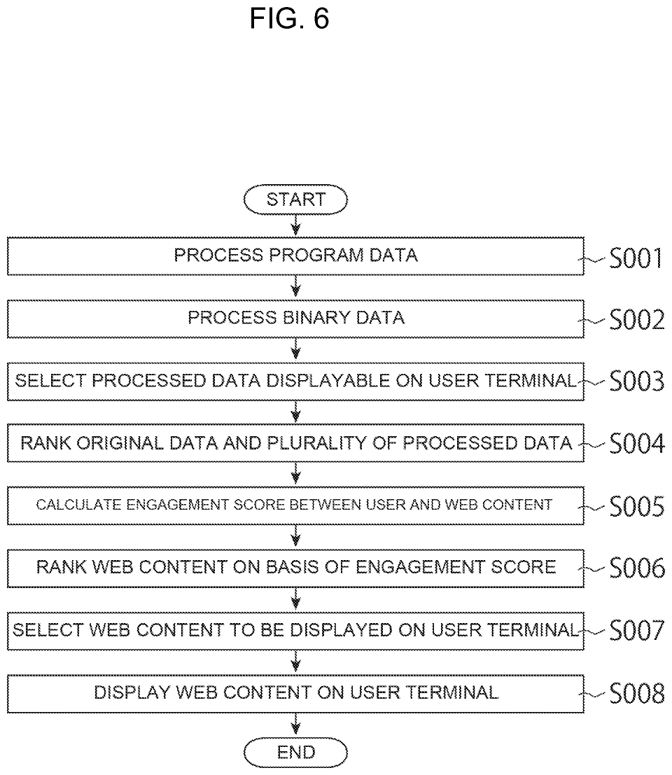

FIG. 6 is a flowchart for explaining the relationship between processed data generation and resource optimization.

It is assumed that the original data 200 is normally displayable on the user terminals 101 of all users written in a model information file.

This is because the original data 200 normally is created so that display problems do not occur on the user terminals 101.

In the hypothetical case where the original data 200 has a problem, the problem is detected and corrected individually using an emulator such as a headless browser installed in the file server 103, for example.

First, the program data and the binary data included in the original data 200 is processed.

As illustrated in FIG. 5 above, the program data includes one or more types of data such as the HTML file 113, the CSS file 107, and the script language file 108, for example.

The program data may be generated dynamically immediately after the web server 103 receives a request from the user terminal 101, or may be generated in advance before the web server 103 receives a request from the user terminal 101.

Also, the binary data includes one or more types of data such as image files, audio files, and video files.

In Embodiment 1 according to the present invention, the HTML file 113 is adopted as an example of program data including a markup language, for example.

The web content displayed on the user terminal 101 according to the original data 200 ordinarily includes a plurality of web pages. A plurality of HTML files 113 correspond to each of the web pages, respectively. In the case of FIG. 5, this is indicated by the HTML file 113.

Each HTML file 113 is a unit that can be displayed on the browser of the user terminal 101 without having to perform a reload operation.

As illustrated in the flowchart of FIG. 6, the program data including a markup language and the like is processed, for example (step S001).

Examples of the processing of the program data including a markup language include the removal of text data that can be omitted from the markup language or the like, compression, rearrangement of the processing order, or changing the processing timing.

The processing of the program data including a markup language and the like includes the case of treating each portion of the data, such as the program data and binary data referenced from within the markup language or the like, as an object. By treating respective portions such as the program data referenced from within the markup language and the binary data referenced from within the markup language as objects defined within the program data including a markup language and the like, processed data can be generated easily.

Note that an object means an entity that can be handled by a computer such as the user terminal 101 or the web server 103, and refers to a concept including one or more types of entities such as variables, arrays, functions, and programs, for example.

A style sheet, a script language, and the like referenced from within the markup language and the like are processed similarly (step S001).

Binary data and the like referenced from within the markup language and the like is also processed (step S002).

The processes in steps S001 and S002 are performed in series, but may also be performed at the same time in parallel.

The processing from step S001 to step S002 is performed on each element included in the original data 200. In other words, the processing is performed on the program data and the binary data included in the original data 200.

The processing of each element included in the original data 200 is performed once or a plurality of times on the same element to be processed.

Processed data such as processed program data and processed binary data is obtained in correspondence with the number of times the processed is performed on each element.

Next, processed data 201 displayable on the user terminal 101 is selected from among the plurality of processed data (step S003).

The processing from step S001 to step S002 above is performed on each element included in the original data 200.

In contrast, in step S003, singular processed data 201 is generated by combining processed elements. The singular processed data 201 corresponds to a single web page. A plurality of processed data 201 with different display completion times is generated for one type of user terminal 101. Each web page is a single unit to be displayed in the browser of the user terminal 101 without performing a reload operation by the browser.

Similarly, respective pluralities of processed data 201 are generated for each web page included in the entire original data 200.

Next, the data that are displayable on one type of user terminal 101 from among the original data 200 and the plurality of processed data 201 are ranked according to the display completion time for the user terminal 101 (step S004).

Through similar steps, all of the processed data 201 is ranked.

Next, the engagement score between the user and the web content is calculated (step S005).

The lowest engagement score is assigned as a relative value of 0 for the engagement score related to a user who has never transmitted a request to the web server 103 carrying out Embodiment 1 of the present invention.

With respect to the engagement score related to a user who has transmitted a request to the web server 103 at least once, the action of transmitting a request to the web server 103 is one user experience, and therefore the engagement score is increased.

Additionally, the engagement score is increased every time a user performs an action with a rich user experience, such as visiting the web site many times, staying on the web site for a long time, revisiting the web site after a short interval, following a link established on the web site, clicking a button or the like many times, playing back a video file, audio file, or the like for a long time, or clicking a video file, audio file, or the like many times. As a result, a high engagement score is assigned to users with a rich user experience. For users with a maximized user experienced, the engagement score is assigned as a relative value of 100.

The engagement score varies as a relative value from 0 to 100.

Next, the web content to be displayed on each user terminal 101 for each display environment of the user terminals 101 of the users is ranked on the basis of the engagement score (step S006).

Steps S001 to S006 are completed when a user has not yet transmitted a request to the web content 103.

Next, the web content to be displayed on a user terminal 101 is selected according to a request transmitted from the user terminal 101 to the web server 103 (S007).

In actuality, immediately after the web server 103 receives the request from the user terminal 101 of the user, the content of the request is analyzed and the web content to be displayed on the user terminal 101 is selected.

In the disclosure of the present invention, “immediately after the web server 103 receives the request” means within 0.2 seconds, or in other words 200 milliseconds, from when the web server 103 receives the request from the user terminal 101. Preferably, the above time is 100 milliseconds or less.

The time from when a person receives information using the five senses such as the sense of sight or hearing until the person actually starts to act is approximately 0.2 seconds. If the web server 103 responds within 200 milliseconds, it is possible to make the user using the user terminal 101 feel as though the web content is being displayed in real time.

Next, the web content to be displayed on a user terminal 101 is selected according to a request transmitted from the user terminal 101 to the web server 103 (S007).

Finally, the web content is displayed on each user terminal 101 (S008).

Through the above steps, the automatic display control method for web content according to Embodiment 1 of the present invention can be carried out.

[Step of Generating Processed Data]

Next, the step of generating the processed data 201 from the original data 200 will be described in detail.

To resolve the conflicting intentions between a user who views web content displayed on a web site and an operator of the web site, and promote the common interests of both parties, it is necessary to optimize all of the resources forming the individual web pages included in the web content for each user environment, reduce the total amount of overall resources, and shorten the program execution time for displaying web pages on the user terminal 101.

Shortening the execution time of each program is beneficial to both the user and the site operator.

The step of generating the processed data 201 is performed at a time at least one of before the web server 103 receives a request from the user terminal 101 and immediately after the web server 103 receives the request from the user terminal 101.

For example, the markup language includes a document containing letters, numerals, symbols, and the like that can be displayed on the user terminal 101 and read directly by the user. The document may also contain information necessary for displaying on the user terminal 101, such as the Documents Object Model (DOM) and Nodo objects forming the tree structure of the DOM.

Nodo objects include markup, that is, symbols for identifying paragraphs, headings, bullet points, and the like.

By tracking which markup is specified in the style sheet, script language, and the like among the markup included in the markup language, the control unit 112 of the PST controller 110 can automatically detect which portions of the document included in the markup language are controlled by the HTML file, the CSS file, the script language file, and the like.

For example, reference portions included in the markup language, or in other words, each of a plurality of code portions of an HTML file written directly in the HTML file 113 that is one type of markup language, a plurality of code portions of a style sheet written directly in the HTML file 113 that is one type of markup language, a plurality of code portions of a script language written directly in the HTML file 113 that is one type of markup language, portions referencing an external style sheet written in the HTML file 113 that is one type of markup language, portions referencing an external script language written in the HTML file 113 that is one type of markup language, portions referencing external binary data written in the HTML file 113 that is one type of markup language, and the like are program objects with an identification number. In addition, the objects are defined as objects in processed HTML files 131.

The objects are saved in the processed data storage area 130 (see FIG. 5).

Note that in the disclosure of the present invention, JavaScript® is used as the program for handling objects. The program for handling objects is not particularly limited insofar as the above objective can be achieved.

Thereafter, the processed HTML files 131 containing data stored as program objects are generated. The processed HTML files 131 are generated multiple times in correspondence with each of a plurality web pages forming the web content 211 included in the original data 201.

The multiple generated processed HTML files 131 may be generated statically or dynamically.

One or more of the multiple generated processed HTML files 131 exist in correspondence with a single web page displayed in the browser without reloading.

In addition, one or more exist according to the type of user terminal 101.

In the disclosure of the present invention, objects defined by a program to be used in each of the processed HTML files 131 are assigned respective identification numbers and saved in the processed data storage area 130. The identification numbers can be used to specify the code portions, reference portions, and the like to be processed.

Also, binary data to be processed such as image files, audio files, and video files included in the original data 200 can be specified from portions referencing external binary data written in the data as objects defined by a program.

In Embodiment 1 of the present invention, the resources of at least one of the original data 200 and the plurality of processed data 201 include at least one of program data and binary data.

Also, the program data includes one or more types of programs such as a markup language, a programming language, a style sheet, and a script language.

On the other hand, the binary data includes one or more types of files such as image files, audio files, and video files.

From these resources such as programs and files, the code portions of a program to be executed and the code portions of program not to be executed are respectively specified for each display environment of the user terminals 101.

On the other hand, the display environment of each user terminal 101 is the environment displayable on the display device 1104 of each user terminal 101, and is determined for each user terminal 101 according to factors such as the type of user terminal 101, the type of OS, the type of browser, the size of the display device 1104, and the number of display pixels per unit area.

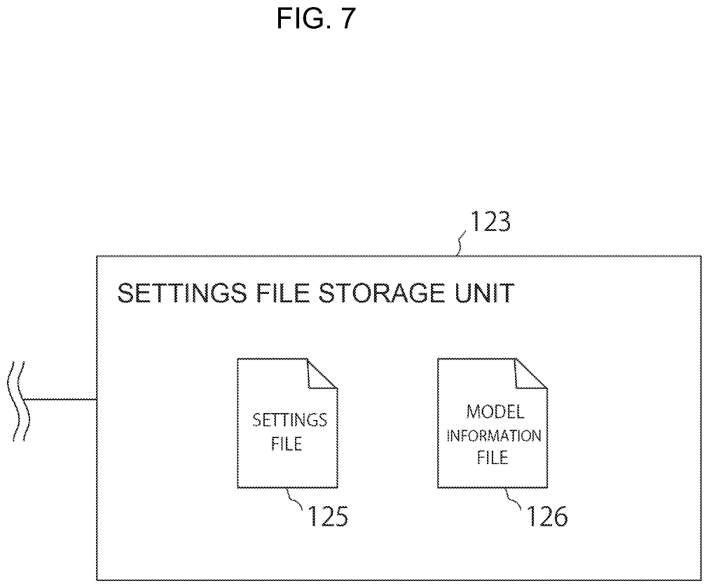

FIG. 7 is a schematic diagram for explaining a settings file 125 and a model information file 126 saved in the settings file storage unit 123 of the storage device 1101 of the web server 103.

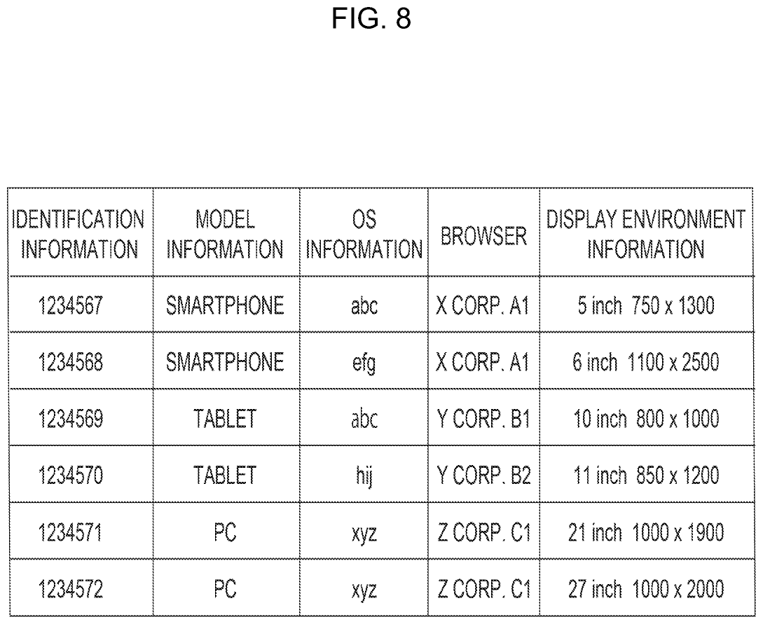

FIG. 8 is a conceptual diagram illustrating one example of the model information file 126 saved in the settings file storage unit 123 of the storage device 1101 of the web server 103 used in a first embodiment of the present invention.

Different types of user terminals 101 exist, including a mobile information terminal such as a smartphone or a feature phone, an information display terminal such as a PDA or a tablet, a wearable communication terminal such as a smartwatch or smart glasses, and a computer such as a PC.

Additionally, even among smartphones, for example, there are differences in the display environment, such as differences in the installed OS, differences in the installed browser, different sizes of display screen, and different numbers of pixels in the display screen.

These differences in the display environment are specified by published model information that is obtainable for each user terminal 101.

The display environment specifications of user terminals 101 are published by organizations such as the manufacturer of each user terminal 101. The display environments for the user terminals 101 are organized on the basis of the published information. A plurality of display environments exist for each user terminal 101.

As illustrated in FIG. 8, identification information for specifying the user terminal 101 and corresponding information such as model information indicating whether a certain user terminal 101 is a mobile information terminal, an information display terminal, or a computer, OS information about the type of OS installed in the user terminal 101, browser information about the browser installed in the user terminal 101, and display environment information indicating the number of pixels in the display screen and the size of the display screen of the user terminal 101 are stored in the model information file 126.

Note that although the data is listed in a table format for convenience in FIG. 8, in actuality, the data is saved in any of various file formats such as json, csv, or tsv, a database format, or the like.

Normally, the user terminals 101 are mass-produced and supplied to the market. For this reason, the display environments of the user terminals 101 are standardized for the most part. The information about display environments stored in the model information file 126 in the settings file storage unit 123 is not infinite, and can be organized into the model information file 126 in a finite time.

The model information file 126 may include individual information about all user terminals 101 or group information obtained by grouping the information for user terminals 101 belonging to certain categories. The group information is not limited to being expressed in any particular way insofar as the display environment of any one user terminal 101 can be specified from the group information on the basis of the model information file 126 when the user terminal 101 is selected.

The control unit 112 of the PST controller 110 respectively specifies the code portions of a program to be executed and the code portions of a program not to be executed for each display environment of the user terminals 101 from the data such as the programs and files described above on the basis of the display environments of all user terminals 101 written in the model information file 126.

Specific examples of code portions of a program to be executed include, for example, code portions of a program that contributes to a portion displayed on the display device 1104 of the user terminal 101.

Specific examples of code portions of a program not to be executed include, for example, code portions of a program that contributes to a portion not displayed on the display device 1104 of the user terminal 101.

For example, the code portions of a program used only for smartphones is not used in user terminals 101 other than smartphones, and therefore the code portions of program used only for smartphones corresponds to the code portions of a program not to be executed for user terminals 101 other than smartphones.

The code portions of a program to be executed and the code portions of a program not to be executed are usually different for each user terminal 101.

To specify the code portions of a program to be executed and the code portions of a program not to be executed for each user terminal 101, a preliminary test is actually performed in advance to determine the respective code portions for each user terminal 101 on the basis of the information about all user terminals 101 written in the model information file 126.

Repeating the preliminary test reveals a trend that roughly indicates which portions of the original data 200 are the code portions of a program that needs to be executed for each user terminal 101.

However, an accurate determination of which portions of the original data 200 correspond to a program that needs to be executed for a user terminal 101 can be determined for all of the user terminals 101 by actually performing a preliminary test in advance for each user terminal 101.

Note that in the disclosure of the present invention, “in advance” means before the user actually transmits a request to the web server 103 from the browser or the like of the user terminal 101.

In the disclosure of the present invention, the same environment as the browser environment installed in the user terminal 101, referred to as an emulator such as a headless browser, is installed in the control unit 112 of the PST controller 110 of the web server 103. The emulator can be used to perform the preliminary test.

If a code portion actually corresponds to a code portion of a program to be executed but is incorrectly determined to be the code portion of a program not to be executed and is removed, a display problem may occur on the user terminal 101.

It is possible to check in advance whether or not a problem will occur by performing a preliminary test using a browser emulator corresponding to the user terminal 101 installed in the web server 103, and checking whether or not an error signal is produced. If the control unit 112 of the PST controller 110 of the web server 103 detects an error signal, the stage at which the problem occurs when selecting a code portion of a program not to be executed can be specified.

The preliminary test is used to ascertain, to a certain degree, which portions of the original data 200 are code portions of a program not to be executed. However, in situations where preliminary information does not exist, such as when a program has never been executed before, details are unclear about which portions of the original data 200 correspond to a program not to be executed.

Accordingly, for example, starting from a state in which no error is occurring in the browser installed in a single user terminal 101, an operation of removing the code portions of a program not to be executed one at a time from the program is repeated. Thereafter, when it is first detected that the browser installed in the user terminal 101 has produced an error signal, the code portion of a program not to be executed that was last removed is determined to correspond to the code portion of a program that should be executed.

As another example, an operation of removing the code portions of a program not to be executed one at a time from the program and saving captured images of the display content on the user terminal 101 reproduced in an emulator as successive image files is repeated.

By comparing a captured image based on the original data 200 to the subsequently captured images, the code portion of a program not to be executed that was last removed at the time when the captured images no longer matched is determined to correspond to the code portion of a program that should be executed.

The above operation is used to determine which portions of the original data 200 are actually the code portions of a program that need to be executed for a single user terminal 101.

A program for achieving the above operation is saved in the control unit 112 of the PST controller 110 of the web server 103. By executing the program saved in the control unit 112 of the PST controller 110, the above operation is performed automatically.

The preliminary test is actually performed in advance by repeating the above operation on the basis of the information about all user terminals 101 written in the model information file 126. From the results of the preliminary test, information about the code portions of a program to be executed and the code portions of a program not to be executed for each user terminal 101 is specified for all of the user terminals 101. The specified information is saved in the settings file storage unit 123 in association with the model information file 126.

Next, a step of determining the execution order of the code portions of a program to be executed with priority and the code portions of a program to be executed with a delay among the plurality of code portions of a program to be executed that are specified for each user terminal 101 will be described.

In the disclosure of the present invention, the display of portions of the web content 211 initially displayed on the screen of the user terminal 101, also referred to as above the fold, is prioritized.

The content included in above the fold is the most important content when a user views a web page included in the web content 211, and resources related to header ads or the like forming the content included in above the fold are the most important for the site operator.

According to the user engagement, the resources forming above the fold are delivered as quickly as possible, while all other resources not forming above the fold are delivered later or removed in some cases.

Minimizing the display completion time of above the fold makes it possible to secure benefits and balance the interests of both the user and the site operator.

If data unrelated to the display of above the fold is transmitted from the web server 103 to the user terminal 101 first, the display of above the fold on the user terminal 101 will be delayed because of the time taken to process the data unrelated to the display of above the fold on the user terminal 101.

To prevent this delay, among the programs related to the display information included in the HTML file 113, the CSS file 107, and the script language file 108, the execution of programs unrelated to the display of above the fold is deferred while the execution of programs related to above the fold is prioritized. Moreover, the execution timings of the programs are also adjusted.

By changing the execution order and the execution timings of the programs in this way, the display of above the fold can be completed quickly, and user bounce from the web site can be reduced.

Note that the way in which the display of above the fold is achieved will be described in further detail in Embodiment 2 according to the present invention.

Next, the step of generating the processed data 201 will be described specifically.

The step of generating the processed data 201 is performed for each of one or more types of program data such as a markup language, a programming language, a style sheet, and a script language included in the original data, and for one or more types of binary data such as image files, audio files, and video files included in the original data.

As described above, the code portions of a program included in the one or more types of program data such as a markup language, a programming language, a style sheet, and a script language included in the original data form respective program objects with an identification number in the processed HTML files 131.

Similarly, reference portions related to one or more types of files such as image files, audio files, and video files included in the original data referenced by the code portions of a program also form program objects with an identification number together with the code portions in the processed HTML files 131.

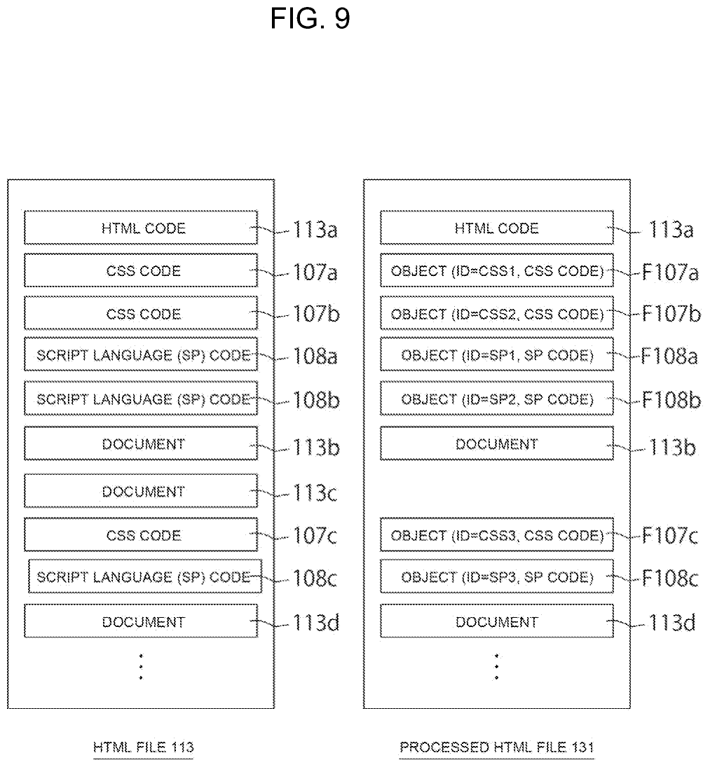

FIG. 9 is a conceptual diagram for explaining a correspondence relationship between an unprocessed HTML file and a processed HTML file.

By processing the original data 200, a plurality of processed data 201 is generated for each display environment of the user terminal 101.

In other words, a plurality of processed data 201 is generated for a single user terminal 101. The processed data 201 is generated by specifying identification numbers to call the respective code portions of a program corresponding to respective objects from among the objects defined by the program, and making alterations such as addition, relocation, removal, or modification of the called code portions of a program.

As illustrated in FIG. 9, the HTML file 113 included in the original data 200 includes HTML code portions 113a, 113b, 113c, CSS code portions 107a, 107b, 107c, script language code portions 108a, 108b, 108c, and the like.

The CSS code portions 107a, 107b, 107c are respectively defined together with an identification number as program objects F107a, F107b, F107c and the like.

Similarly, the script language code portions 108a, 108b, 108c are respectively defined together with an identification number as program objects F108a, F108b, F108c and the like.

The step of generating the processed data 201 is also performed on document portions other than the code portions included in the program data including a markup language, a programming language, a style sheet, a script language, and the like.

The step of generating the processed data 201 includes one or more steps such as a step of removing unnecessary portions, a step of compressing necessary portions, a step of changing the execution order, a step of changing the execution timing, or a step of shortening overlapping execution time, and also includes one or more steps such as a step of converting one or more properties of the binary data, such as the number of display pixels per unit area, the image or sound recording density per unit time, the data size, or the save format.

[Step of Removing Unnecessary Portions for Each User Terminal Display Environment]

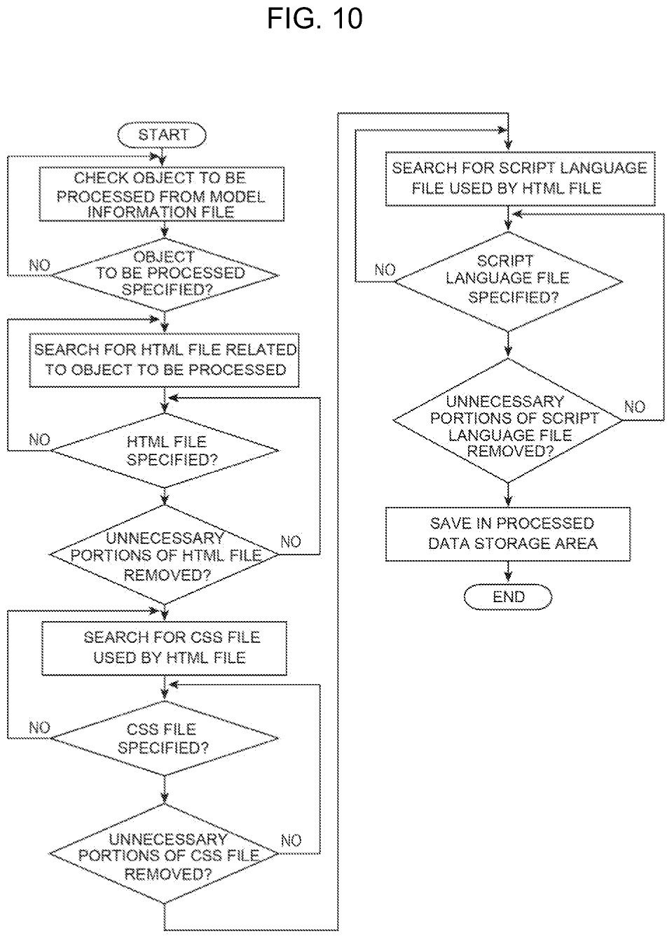

FIG. 10 is a flowchart for explaining a step in which unnecessary portions are removed for each user terminal display environment.

Note that in the case where a corresponding process is not executed successfully even after a certain number of attempts, the step is ended and the process in the next step is executed. The same applies to the steps hereinafter.

For each user terminal 101 specified on the basis of an identification number in the model information file 126, the HTML file 113 to be used by the user terminal 101 and data such as the CSS file 107 and the script language file 108 referenced during the execution of the HTML file 113 are specified, for example. The above files are specified by designating the identification numbers for the objects associated with the programs illustrated in FIG. 9.

Additionally, a portion 113x of the HTML file 113 not used by the user terminal 101, a portion 107x of the CSS file 107 not used by the user terminal 101, and a portion 108x of the script language file 108 not used by the user terminal 101 are specified from within the HTML file 113, the CSS file 107, and the script language file 108, respectively.

From these files, the portions 113x, 107x, and 108x not used by the user terminal 101 are removed.

Specifically, for example, in the case where the user terminal 101 specified on the basis of an identification number in the model information file 126 is a PC, the information of the portions corresponding to a mobile information terminal and an information display terminal included in any of the HTML file 113, the CSS file 107, and the script language file 108 is removed.

Conversely, for example, in the case where the user terminal 101 specified on the basis of an identification number in the model information file 126 is a smartphone, the information of the portions not used for a smartphone from among the information included in any of the HTML file 113, the CSS file 107, and the script language file 108 is removed.

The HTML file 113 includes markup, that is, symbols for identifying paragraphs, headings, bullet points, and the like.

By tracking which markup is specified among the markup included in the HTML file 113 and following the markup specified by the CSS file 107 and the script language file 108, the respective portions of the HTML file 113 that are controlled by the CSS file 107 and the script language file 108 are ascertained.

The removal of unnecessary portions of the processed data by the control unit 112 of the PST controller 110 is achieved on the basis of the display environments of all user terminals 101 listed in the model information file 126 by causing the control unit 112 of the PST controller 110 to follow the information indicating which portions of the HTML file 113 are controlled by the CSS file 107 and the script language file 108.

Next, the user does not view each of the HTML file 113, the CSS file 107, and the script language file 108 directly, for example.

The user views the web content 211 generated by the HTML file 113 and the like through the browser of the user terminal 101.

On the other hand, for example, the HTML file 113, the CSS file 107, and the script language file 108 each include display information tailored to be human-readable when the contents of these files are displayed in a CLI or the like. The display information is information necessary for the administrator of the web server 103, but is not reflected in the web content 211, and therefore is unnecessary information to the user who uses the user terminal 101.

Some of the display information included in the HTML file 113, the CSS file 107, and the script language file 108 may be removed without affecting the display of the web content 211. Such display information is removed.

Examples of the display information to be removed include spaces, tabs, and line break information indicating line breaks or paragraph delimiters that do not affect the display of the web content 211, and text information such as warnings for maintenance and management written in each file.

The removal of unnecessary portions of the processed data is achieved on the basis of the display environments of all user terminals 101 listed in the model information file 126 by causing the control unit 112 of the PST controller 110 to analyze the display information included in the HTML file 113, the CSS file 107, and the script language file 108.

In actuality, the removal is achieved by simply specifying nothing (null) in the objects of the corresponding objects to be removed, for example.

[Step of Compressing Necessary Portions for Each User Terminal Display Environment]

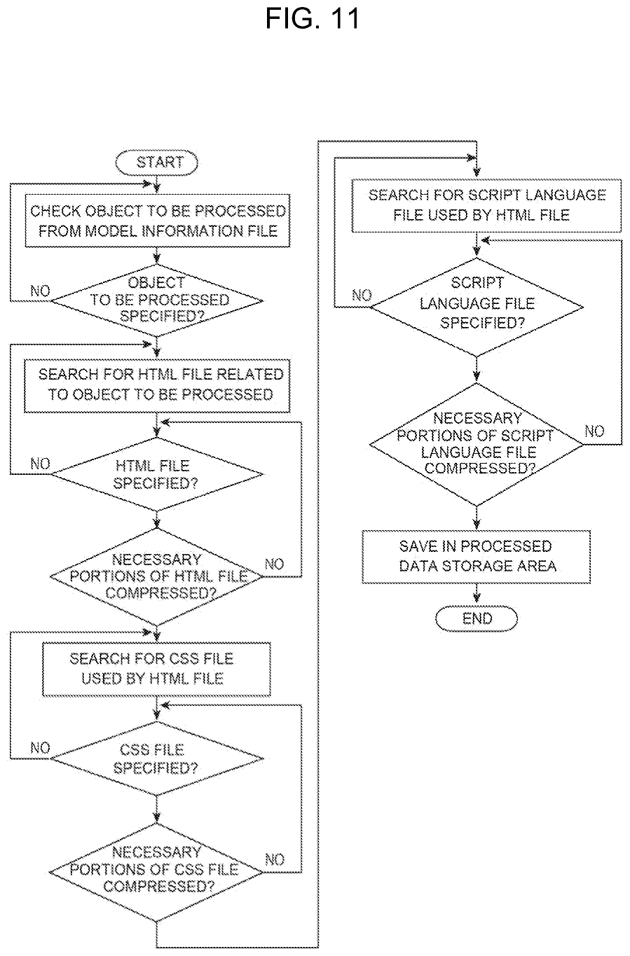

FIG. 11 is a flowchart for explaining a step in which necessary portions are compressed for each user terminal display environment.

In general, there are multiple methods of expressing the same piece of information. For example, the notation “1,000,000” meaning the number one million can be denoted as “10E6”, meaning ten to the sixth power. The former needs nine characters including the commas indicating digit grouping, whereas the latter can be expressed in four characters including the letter character.

The operation of converting the same piece of information into a different form of representation that can be processed more quickly by the web server 103 and the user terminal 101 is referred to as compression in the disclosure of the present invention.

Such a compression operation can be performed using one or more existing types of lossless compression technology such as LHA, ZIP, GZIP, or Brotli, for example.

For example, the compression of necessary portions is achieved by the control unit 112 of the PST controller 110 for one or more of the HTML file 113, the CSS file 107, the script language file 108, or the processed data thereof.

Note that in the step of compressing the necessary portions, one or more types of compression formats can be used. Also, in the step of compressing the necessary portions, all of the necessary portions may be compressed or some of the necessary portions may be compressed.

[Step of Changing Execution Order]

Among the web content 211, the code portions of a program related to the portions of the web content 211 initially displayed on the screen of the user terminal 101, referred to as above the fold, are executed first. Next, among the web content 211, the code portions of a program related to portions of the web content 211 other than the portions initially displayed on the screen of the user terminal 101, referred to as above the fold, are executed later.

As described above, with regard to the execution order, the display of portions of the web content 211 initially displayed on the screen of the user terminal 101, also referred to as above the fold, is prioritized.

The code portions of a program included in the one or more types of program data such as a markup language, a programming language, a style sheet, and a script language included in the original data are ordinarily performed on the web server 103 side in the order in which the code portions are written.

However, in the case where the code portion of a program that should be executed first contains a reference to a code portion of a program executed later, the code portion of the program that should be executed first stands by until the code portion of the program executed later is loaded on the web server 103 side.

This standby time is usually short enough to be negligible for the program code portions individually, and therefore is easily overlooked.

However, as the original data increases in scale, the impact of the standby time tends to increase. If the impact of the standby time is ignored, the standby time may become one factor that induces user bounce from a web site. For this reason, the execution order is changed and processed so that unwanted standby time does not occur.

Specifically, in the case where the code portion of a program references the code portion of a program to be executed later, the code portion of the program to be executed later is moved up and executed early.

Also, in some cases, the code portion of a program references an element that cannot be executed, such as in the case of referencing a code portion or the like that existed in the past but does not currently exist, or in the case of referencing a variable that does not currently exist, for example. In such cases, the problematic code portion is skipped without being executed, for example, and later code portions are performed first.

For programs other than the code portions of a program related to above the fold, the execution order is changed and execution is deferred.

Among the programs whose execution is deferred, factors such as whether to execute the programs synchronously, to execute the programs asynchronously, to prioritize execution, or to prioritize execution are controlled according to a program written in the control unit 112 of the PST controller 110 installed in the web server 103.

[Step of Changing Execution Timing]

With regard to the execution timing, after the completion of executing the code portions of a program related to the display of the portions of the web content 211 initially displayed on the screen of the user terminal 101, referred to as above the fold, the execution of programs related to the display of the portions of the web content 211 other than above the fold is started.

The execution timing is adjusted for actions such as forming the DOM, downloading content associated with the DOM tree structure to the user terminal 101, and downloading major resources such as image files, audio files, and video files.

For the code portions of programs that affect each other, the execution timings of the code portions of programs are adjusted synchronously such that the when the execution of the code portion of one program ends, the execution of the code portion of the next program begins.

Also, for the code portions of programs that do not affect each other, the respective execution timings of the program code portions are adjusted asynchronously.

[Step of Shortening Overlapping Execution Time]

On the other hand, the execution times of the programs written in each of the HTML file 113, the CSS file 107, and the script language file 108 are also adjusted.

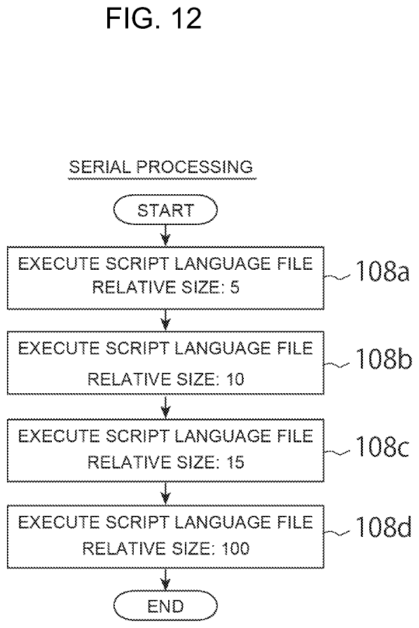

FIG. 12 is a diagram for explaining a step in which script language file portions 108a to 108d written in the HTML file 113 are executed serially.

Reference information for the plurality of script language file portions 108a to 108d is written in the HTML file 113.

When the HTML file 113 is executed, the script language file portions 108a to 108d are normally executed serially in the above order.

At this point, suppose for example that the display completion time of the script language file 108d has a relative value of 100, while the display completion times of the script language file portions 108a to 108c have relative values of 5, 10, and 15, respectively.

If the script language file portions 108a to 108d are executed in the above order, the process until the display on the user terminal 101 is completed demands a display completion time corresponding to 5+10+15+100=130 based on the relative values of the display completion times.

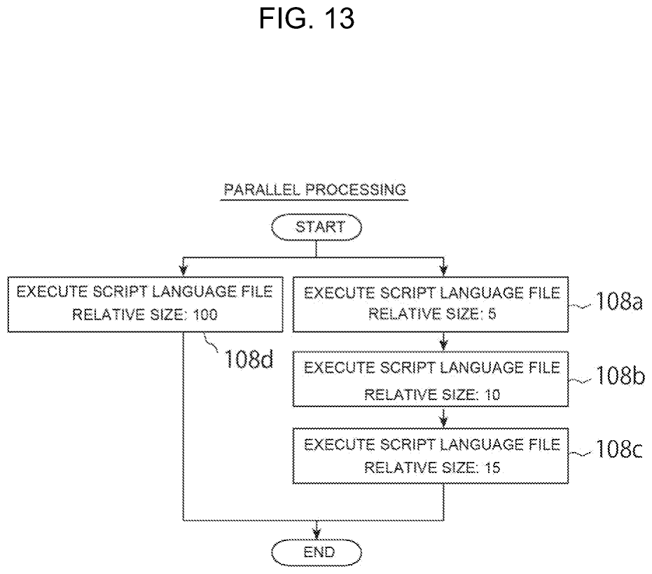

FIG. 13 is a diagram for explaining a step in which the script language file portions 108a to 108c are executed in parallel with the script language file 108d written in the HTML file 113.

In this case, by reorganizing the execution order of the script language file 108, the time to generate the web content 211 can be shortened.

In the case of FIG. 13, the HTML file 113 is processed such that the script language file portions 108a to 108c are processed at the same time in parallel with the execution of the script language file 108d.

Through this processing, while the process corresponding to a relative value of 100 for the display completion time of the script language file 108d is being executed, the processes with a display completion time corresponding to 5+10+15=30 based on the relative values of the display completion times can be completed.

With this arrangement, the display completion time of the script language file portions 108a to 108d can be reduced from 130 to 100 based on the relative values.

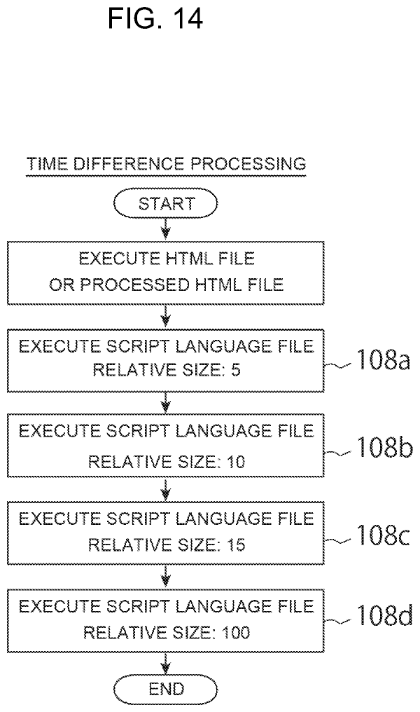

FIG. 14 is a diagram for explaining a step in which the execution of the script language file 108d written in the HTML file 113 is deferred.

The HTML file 113 may also be processed such that information referencing only the script language file portions 108a to 108c is written in the HTML file 113 first, and the script language file 108d is referenced at the end of the HTML file 113.

By processing the HTML file 113 in this way, the execution of the other script language files 108a to 108c can be started without waiting for the processing of the script language file 108d having a relatively long execution time.

The question of which files should be processed in which order to achieve optimization can be determined by actually changing the order to measure and compare the display completion time of the web content 211 for each of the user terminals 103.

The step of generating the processed HTML files 131, processed CSS files 132, and processed script language files 133 is performed for all user terminals 101 listed in the model information file 126.

By tracking how and in what order the HTML file 113 processes the plurality of script language file portions 108a to 108c and the like, the generation of new processed data 201 is achieved by the control unit 112 of the PST controller 110 on the basis of the display environments of all user terminals 101 corresponding to the content written in the model information file 126.

Through the above step, the data of at least one selected from the group consisting of a markup language, a style sheet, and a script language included in the original data 200 can be processed.

[Step of Reducing Size of Binary Data by Converting One Selected from the Group Consisting of the Number of Display Pixels Per Unit Area, the Image or Sound Recording Density Per Unit Time, the Data Size, and the Save Format]

Next, all of the image files 109 and the like referenced by the HTML file 113, the CSS file 107, the script language file 108, and the like are used to generate processed image files 134 having different display sizes, file sizes, and types for each user terminal 101 specified on the basis of an identification number in the model information file 126.

The display size of an image file 109 is changed by generating a plurality of processed image files 134 having different heights and widths, without changing the aspect ratio of the width with respect to the height, for example.

The size of an image file 109 is changed by changing properties of the image file 109 such as the number of pixels per unit area or the image or sound recording density per unit time, for example.

The type of the image file 109 is changed by converting from a type such as PNG to a type such as JPEG, WEBP, or JPEG2000, for example.

The step of generating the processed image files 134 is performed for all user terminals 101 listed in the model information file 126.

Through the above step, processed data 201 including a plurality of new, converted binary data is generated.

In the case where the binary data is a video file, a sound file, or the like, processed data 201 including a plurality of new, converted binary data can be generated according to a similar procedure.

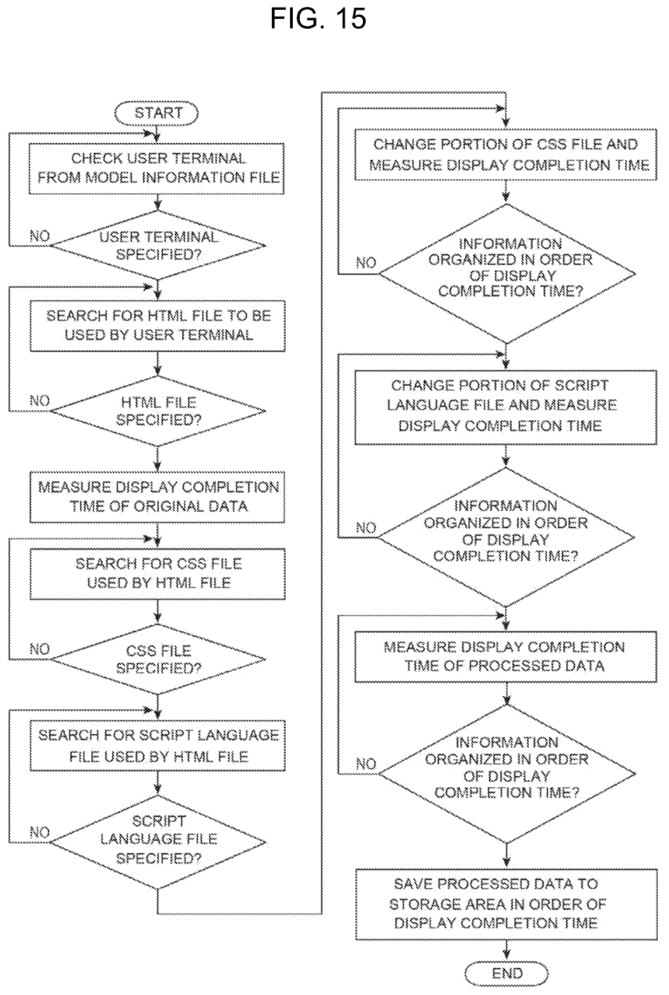

FIG. 15 is a flowchart for explaining a step in which processed data is generated.

For example, in addition to measuring the display completion time of the original data, the display completion time is measured for each of the processed HTML files 131, the processed CSS files 132, and the processed script language files 133.

For the plurality of processed HTML files 131, how long the display completion time takes as an element is measured in comparison to the unprocessed HTML file 113.

For the processed CSS files 132, how long the display completion time takes as an element is measured in comparison to the unprocessed CSS file 107.

For the plurality of processed script language files 133, how long the display completion time takes as an element is measured in comparison to the unprocessed script language file 108.

Likewise, for the binary data, how long the display completion time takes as an element is measured in a comparison between the plurality of processed image files or the like and the unprocessed image file or the like.

The above information is generated for each display environment of the user terminals 101 according to the information in the model information file 126 at a time at least one of before the web server 103 receives a request from a user terminal 101 and immediately after the web server 103 receives the request from the user terminal 101.

Note that although FIG. 15 illustrates an example of serial processing, the processes may also be performed in parallel.

According to the above step, the original data 200 and the plurality of processed data 201 are prepared for each of the user terminals 101.

Note that it is not necessarily the case that selecting the respective elements with the shortest display completion times included in the original data 200 and the plurality of processed data 201 will yield the shortest display completion time overall from among the original data 200 and the plurality of processed data 201.

This is because respective elements influence each other depending on the combination of elements, and the display completion time varies for each of the original data 200 and the plurality of processed data 201.

In the case where it is unclear which among the original data 200 and the plurality of processed data 201 will have the shortest display completion time, a determination is made by actually performing a preliminary test in advance for each user terminal 101.

[Updating Original Data 200 Used in Automatic Display Control Method for Web Content]

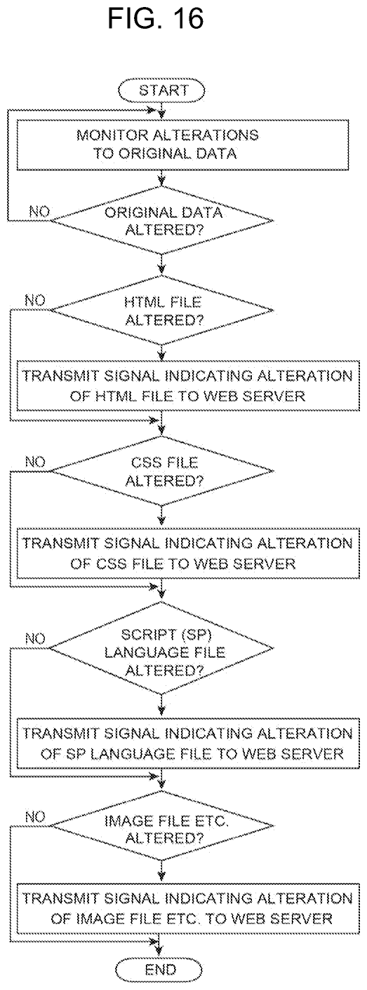

FIG. 16 is a flowchart for explaining a step in which a signal indicating that an alteration such as an addition, relocation, removal, or modification has been made on the original data 200 is transmitted to the operation control unit.

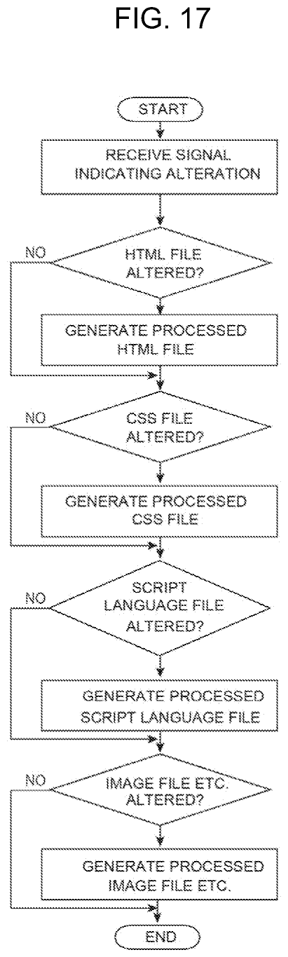

Also, FIG. 17 is a flowchart for explaining a step in which processed data is newly generated according to the signal indicating alteration of the original data 200.

The original data 200 is monitored, and upon detecting that an alteration such as an addition, relocation, removal, or modification has been made on the original data 200, processed data is newly generated.

The original data 200 used in the automatic display control method for the web content 211 that is initially saved in the original data storage area 104 in the storage device 1101 of the web server 103 may continue to be used.

On the other hand, the user normally wants to obtain the most recent information in addition to old information. To accommodate this user desire, the web server administrator normally performs work for updating the original data 200.

Here, the updating of the original data 200 will be described.

To detect that the original data 200 has been altered, it is sufficient to track whether a change has occurred in the original data 200 after a fixed time has elapsed.

The original data 200 is saved in the original data storage area 104. In the case where the original data 200 is altered after a fixed time has elapsed, the altered content is saved in the original data storage area 104.

Additionally, by comparing the content saved earlier to the content saved later, it is possible to detect which portions of the original data 200 are different with a program written in the monitoring control unit 115 illustrated in FIG. 4.

By setting a short time interval for checking whether or not a difference exists, changes can be detected immediately.

In the case where the original data 200 has been altered, the monitoring control unit 115 specifies the altered portions among the HTML file 113, the CSS file 107, the script language file 108, and the image file 109 included in the original data 200.

Additionally, a signal indicating that an alteration has been made is transmitted from the monitoring control unit 115 to the operation control unit 116 and to the control unit 112 of the PST controller 110.

The operation control unit 116 receiving the signal indicating an alteration processes the processed data 201 according to the display environment of the user terminal 101 for the altered portions of the original data 200, and generates new processed data 202.

The data corresponding to the altered portions of the processed data 201 saved in the processed data storage area 114 of the web server 103 is replaced by the processed data 202.

In the disclosure of the present invention, if information related to the most recent save time, also referred to as a timestamp, with respect to data related to the original data 200 is changed, for example, the corresponding portions of the preexisting processed data 201 or the like may also be replaced by the dynamically generated processed data 202 without actually investigating whether or not the original data 200 or the like has been altered.

When the original data 200 is altered, an operation of replacing the processed data 201 generated earlier with the processed data 202 newly generated in association with the alteration of the original data 200 is performed continually at nearly the same time as the alteration.

A command is received from the control unit 112 of the PST controller 110, a program written in the PST plugin 111 runs, and the processed data 202 corresponding to the display environment of the user terminal 101 is extracted, processed, and saved in the operation control storage unit 117.

Through the above step, the processed data 201, 202 corresponding to the display environment of the user terminal is newly generated from the original data 200 saved in the storage area usable by the web server 103, before the web server 103 receives a request from the user terminal 101.

[Step of Specifying Display Environment of User Terminal]

Next, the step in which the web server 103 specifies the display environment of the user terminal 101 after the web server 103 receives a request from the user terminal 101 will be described.

When the user terminal 101 is connectible to the web server 103 over the network 102, a request is transmitted from the user terminal 101 to the web server 103 through the network 102. Thereafter, the request transmitted from the user terminal 101 is received by the web server 103.

The request is issued through the browser installed in the user terminal 101.

The request received by the web server 103 includes information such as a user agent indicating model information about the user terminal 101, the type of browser, the type of OS, and the like, and a referrer indicating which page of a web site displayed in the browser of the user terminal 101 the request was transmitted from.

By using this information such as the user agent and the referrer, the web server 103 can specify the display environment of the user terminal 101 with an accept header, a cookie, or the like.

[Step of Generating Web Content Including Data Displayable in Display Environment of User Terminal]

Next, a step of generating the web content 211 including data displayable in the display environment of the user terminal 101 will be described.

According to the step described above, the web content 211 that can be displayed by each user terminal 101 already has been generated in advance. The web content 211 and the user terminals 101 are associated with each other.

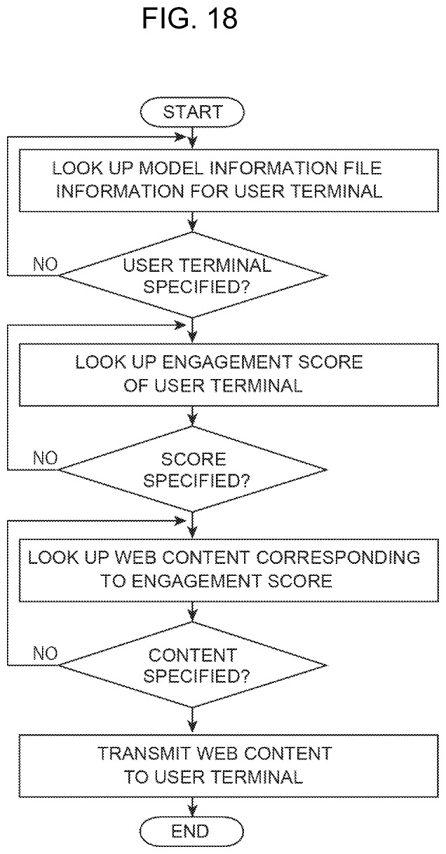

FIG. 18 is a flowchart for explaining the step of generating the web content 211 including data displayable in the display environment of the user terminal 101.

The step of selecting the web content 211 including data displayable in the display environment of the user terminal 101 is performed after a request is transmitted from the browser of the user terminal 101 to the web server 103.

The specification of the display environment of the user terminal 101 is achieved by cross-checking information such as an accept header or a cookie with the model information file 126 described above.

When the display environment of the user terminal 101 is specified, the original data 200 displayable using the display environment is specified, for example. Specifically, for example, information such as the HTML file 113, the CSS file 107, the script language file 108, and the image file 109 included in the original data 200 is specified.

Similarly, when the display environment of the user terminal 101 is specified, the processed data 201, 202 displayable using the display environment is specified, for example. Specifically, information such as the processed HTML files 131, the processed CSS files 132, the processed script language files 133, the image file 109, and the processed image files 134 is specified.

In actuality, information such as respective code portions and file portions in the form of program objects defined in the processed HTML files 131 are saved in the processed data storage area 130.

Approximately how long the display completion time takes in the case of using which objects is ascertained in advance with a preliminary test.

For this reason, immediately after the web server 103 receives the request from the user terminal 101, the web content 211 including data displayable in the display environment of the user terminal is selected by the control unit 112 of the PST controller 110 installed in the web server 103. At this stage, a plurality of pieces of web content 211 displayable on the user terminal 101 exist.

Thereafter, singular web content 211 to be displayed on each user terminal 101 is determined on the basis of the engagement score corresponding to each user terminal 101 described below.

If the HTML file 113 or the processed HTML files 131 are executed on the web server 103 side by the control unit 112 of the PST controller 110, the web content 211 can be transmitted over the network 102 to each user terminal 101 for all user terminals 101 with a specified display environment. The web content 211 corresponding to each user terminal 101 is displayed on each user terminal 101 receiving the web content 211.

[Step of Ranking Optimal Resources Based on Display Completion Time]

Next, for resources such as the original data 200 and the plurality of processed data 201, 202, the display completion times of the web content 211 including the resources such as the original data 200 and the plurality of processed data 201, 202 are actually measured and compared in advance by preliminary tests for each of the user terminals 101.

Through the step of measuring and comparing the display completion times of the web content 211, information indicating which web content 211 is better with regard to the display completion time for the data of each of the resources such as the original data 200 and the plurality of processed data 201, 202 with respect to a single user terminal 101 is respectively saved in the original data storage area 104 and the processed data storage area 130.

The display completion time of the web content 211 largely depends on the program code portions included in the resources such as the original data 200 and the plurality of processed data 201, 202.

Program code portions that have been reduced in size usually have shorter display completion times than program code portions that have not been reduced in size as much, and therefore are preferable.

However, it is not necessarily the case that all code portions of small size have shorter display completion times. Furthermore, for binary data, it is likewise not necessarily the case that data of small size has shorter display completion times.

In some cases, there is also the possibility that the display of the original data 200 will be completed faster than any of the plurality of processed data 201, 202.

Accordingly, in the disclosure of the present invention, information such as the original data 200 and the plurality of processed data 201, 202 is used to perform preliminary tests in advance and measure the display completion times for all of the data with respect to each user terminal 101, and thereby specify the data in the actual order of the shortest display time.

The original data 200 includes a plurality of HTML files 113 respectively corresponding to the plurality of web pages forming the web content 211, and also the program data and binary data referenced and/or executed from each of the plurality of HTML files 113.

In addition, the processed data 201, 202 includes processed data such as a plurality of processed HTML files 113 respectively corresponding to the plurality of web pages forming the web content 211 and also the processed program data and processed binary data referenced and/or executed from each of the plurality of processed HTML files 113.

These resources such as the original data 200 and the processed data 201, 202 are the respective resources necessary to display the web content 211.

Also, among these resources, the resources necessary to display the user terminal 101 for each user terminal 101 of the user are the optimal resources. A plurality of optimal resources exist for every single user terminal 101.

The processed data is generated for each display environment of the user terminal 101 of the user and for each of the resources necessary to display the web content 211.

Also, in the case where the optimal resources executable in each display environment of the user terminal 101 of the user are selected, there is not necessarily a single form of representation necessary to achieve the optimal resources, even if properties such as the sizes of the various files saved in the optimal resources and the extensions specifying the types of the various files are the same. For this reason, even if a plurality of optimal resources that appear to be the same optimal resources exist among the plurality of optimal resources, differences in the display completion times may occur in some cases when the optimal resources are actually executed.

Except for optimal resources having a display completion time that is clearly shorter than other optimal resources, information related to the display completion times among the optimal resources for a single user terminal 101 is determined by actually performing preliminary tests in advance.

For example, for one type of user terminal 101, the web content 211 with the shortest display completion time is assigned to the users with the lowest engagement score. As another example, the web content 211 with rich content and the longest display completion time is assigned to the users with the highest engagement score.

The web content 211 having display completion times other than the web content 211 with the shortest display completion time is assigned respectively according to the value of the engagement score.

By performing this step in advance for all user terminals 101 listed in the model information file 126, the web content 211 and the value of the engagement score are assigned in advance. Before a request is transmitted from the user terminal 101 to the web server 103, an initial value of 1 is assigned as the value of a coefficient ai of an expression (A) described later. This coefficient value is adjusted automatically so as to maximize the user experience through a step of recording changes in the user engagement score and the user experience with respect to the web content 211 by the operation of a learning machine 301 described below.

Which combination of resources is to be selected from at least one resource selected from the group consisting of the processed data and the original data corresponding to the processed data is prioritized by the PST controller 110 on the basis of the data written in the settings file 125.

[Step of Calculating Engagement Score for Each User Terminal]

Next, a step of calculating the engagement score for each user terminal 101 will be described.

The engagement score used in Embodiment 1 according to the present invention is calculated for each user terminal 101 on the basis of the user experience associated with the identification data specifying the user terminal 101 that has transmitted a request to the web server 103 and history data for each user terminal associated with the identification data.

When the user terminal 101 transmits a request to the web server 103, data such as an accept header or a cookie specifying the user terminal 101 is recorded in the database 106 through a program written in the PST plugin illustrated in FIG. 4. This data acts as identification data for specifying the user terminal 101.

Also, actions such as clicking, scrolling, tapping, dragging, and the input of text performed by the user can be detected as events on the web server 103 side through the browser installed in the user terminal 101. This event information is transmitted as a signal to the control unit 112 of the PST controller 110 installed in the web server 103.

The event information transmitted to the web server 103 over the network 102 is analyzed in association with an event handler defined by the control unit 112 of the PST controller 110 of the web server 103 illustrated in FIG. 4. The event information is recorded as history data about each user terminal 101 in at least one of the database 106 and the user terminal 101.

Examples of the history data for each user terminal 101 include one or more of the number of times the user has issued a request to at least one of the web server and the browser, the type of request issued by the user to at least one of the web server and the browser, the time the user stays on the web site, or the period between multiple requests by the user with respect to at least one of the web server and the browser.

Specific examples of the history data are as follows. Examples of the history data for each user terminal 101 include:
the time 301 taken for the user to read text information displayed in the web content 211,
a link 302 that the user views by clicking a link associated with the web content 211 and viewing the content at the link destination, and the number of times 303 that the link 302 is clicked,
a video file 304 that is played back from among video files associated with the web content 211, the number of times 305 that the video file 304 is played back, and the duration 305 of viewing the video file 304,
a music file 306 that is played back from among music files associated with the web content 211, the number of times 307 that the music file 306 is played back, and the duration 307 of viewing the music file 306,
text information 308 inputted into a form field associated with the web content 211 and the number of times 309 that the text information 308 is transmitted,
a product 310 purchased from among products displayed in the web content 211 and the number of times 311 that the product 310 is purchased,
a service 312 requested from among services displayed in the web content 211 and the number of times 313 the service 312 is requested,
the number of times 313 a request is transmitted to the web server 103,
the period 314 from when a request is first transmitted until a request is last transmitted to the web server 103,
the period 315 from the last time a request was transmitted until the current request was transmitted to the web server 103, and
location information 316 estimated from the IP address that transmitted a request to the web server 103. One or more types of data can be selected and used as the history data for each user terminal 101. The history data for each user terminal 101 saved in the database 106 corresponds to the user experience for each user.

The step of calculating the engagement score for each user terminal 101 is performed as follows.

$$\begin{matrix}[ Expression 1 ] & \\ {\sum }_{i = 1}^{k} {a}_{i} \times {f}_{i} & ( A )\end{matrix}$$

Expression (A) is a formula for calculating the engagement score for each user terminal 101.

Here, fi represents functions corresponding to the history data for each user terminal 101, and ai represents a coefficient with respect to each function. Also, i is a natural number, and the values of i respectively correspond to each of the history data. Also, k is the total number of the history data.

The history data for each user terminal 101 is saved in the database 106 as the variable i.

For example, the function fi corresponding to i=1 corresponds to the ratio of the time 301 taken for a specific user to read text information per web site visit with respect to the average time taken for each user to read text information per web site visit.

As another example, i=2 corresponds to the ratio of the type of link 302 clicked by a specific user with respect to the total number of links present in the web content 211.

As another example, i=3 corresponds to the ratio of the number of times 303 that the link 302 is clicked by a specific user with respect to the average number of link clicks by each user per web site visit.

Similarly, ratios of individual user experiences with respect to average history data are associated using the variable fi.

Next, the web content 211 is viewed by the user terminal 101, but if for example a user bounces in less than two seconds and has no viewing history again thereafter, the engagement score is set to zero.

When the initial values of the coefficient ai of Expression (A) above are all set to 1, the value of Expression (A) above for the user expressing the largest value calculated according to Expression (A) is 100.

Note that the adjustment of the coefficient ai will be described later.

Through the above step, a relative value from 0 to 100 is obtained for each user terminal 101 used by all of the users who have transmitted a request to the web server.

Each of these values is the engagement score up to the present time since the web content 211 was published.

The engagement score is increased every time a user views the web content 211. For this reason, the engagement score is not fixed for the user terminal 101 of each user, but changes over time for the user terminal 101 of each user.

For example, a program that calculates the engagement score according to operations performed by the user in the browser or the like installed in the user terminal 101 is inserted into a program object in the processed HTML files 131. Consequently, when the user performs an operation in the browser or the like installed in the user terminal 101, the engagement score corresponding to the operation is calculated and saved in the user terminal 101. The engagement score is transmitted together when a request is transmitted from the browser installed in the user terminal 101 to the web server 103 over the network 102, and is saved in the web server 103.

[Step of Selecting Web Content According to Engagement Score]

Next, a step of selecting the web content 211 according to the engagement score will be described.

A combination of files usable in the display environment of each user terminal 101 can be specified on the basis of the history information for each user and the identification number information of the user terminal 101 associated with the history information, and a plurality of pieces of web content 211 with different display completion times can be generated for each user terminal 101.

At this point, the web content 211 with the shortest display completion time of the web content is selected for users having an engagement score that is less than a certain value.

In this case, for example, the respective types of the referred CSS file 107 and the processed CSS files 132, the script language file 108 and the processed script language files 133, the image file 109 and the processed image files 134 are selected such that as many paragraphs of the text files as possible are removed without producing a problem in the display on the user terminal 101.

As another example, data such as video files, links to video files, ad files, and ad links are removed or the like.

Similarly, the files with the shortest display completion times are respectively specified from among the CSS file 107 and the processed CSS files 132, the script language file 108 and the processed script language files 133, and the image file 109 and the processed image files 134.

For example, for files such as the processed CSS files 132, the processed script language files 133, and the processed image files 134, files in which the content related to data such as removed video files, links to video files, ad files, and ad links have been removed are specified.

The combination of data with the shortest display completion time is specified from among the plurality of processed data 201 and the original data 200 corresponding to the plurality of processed data 201.

The processing of the web content 211 including the combination of data with the shortest display completion time has been completed in advance, and therefore a display completion time within 0.2 seconds, preferably within 100 milliseconds, is actually achievable for the display environment of the user terminal 101 obtained by cross-checking the information such as an accept header or a cookie with the model information file 126.

According to the step described above, there is obtained web content 211 which is transmitted by the web server 103 to users having an engagement score of a certain value or less and which is displayable in the display environment of the specified user terminal 101.

The web content 211 with the shortest display completion time is selected according to preliminary tests performed in advance, and therefore the time it takes to complete the transmission of the web content 211 from the web server 103 to the user terminal 101 can be shortened.

Next, for users having an engagement score of a certain value or more, web content 211 that is not abbreviated or omitted while also being displayed quickly is selected.

Specifically, for example, web content 211 from which data such as video files, links to video files, ad files, and ad links are not removed or the like is selected.

In this case, web content 211 presenting displayable information is selected from among the files usable in the display environment of the user terminal 101.

Specifically, from among the group of files usable in the display environment of the specified user terminal 101, a combination of files having a short display completion time and also no abbreviated or omitted information is extracted according to the type of each file.

For example, the HTML file 113 and the processed HTML files 131 are compared, and a file with a short display completion time from among the files without abbreviated or omitted information is adopted.

Similarly, files with short display completion times from among the files without abbreviated or omitted information are respectively specified from among the CSS file 107 and the processed CSS files 132, the script language file 108 and the processed script language files 133, and the image file 109 and the processed image files 134.

A combination of data with short display completion times from among the data without abbreviated or omitted information is specified from among the plurality of processed data that has been extracted and processed and the original data 200 corresponding to the plurality of processed data that has been extracted and processed.

Web content 211 including the combined data with short display completion times from among the data without abbreviated or omitted information is selected on the basis of the display environment of the user terminal 101 obtained by cross-checking the information such as an accept header or a cookie with the model information file 126, and is therefore compatible with the display screen of the user terminal 101.

Note that in actuality, the portions of the reference information written in the processed HTML files 131 are all replaced with objects. Any of the processed data can be executed immediately on the basis of the identification information corresponding to the objects.

According to the step described above, there is obtained web content 211 without abbreviated or omitted information which is transmitted by the web server 103 to users having an engagement score of a certain value or more and which is displayable in the display environment of the specified user terminal 101.

In this case, the information in the web content 211 is not abbreviated or omitted, thereby preventing user dissatisfaction with respect to incomplete web content 211.

[Step of Learning how to Select Web Content According to Engagement Score]

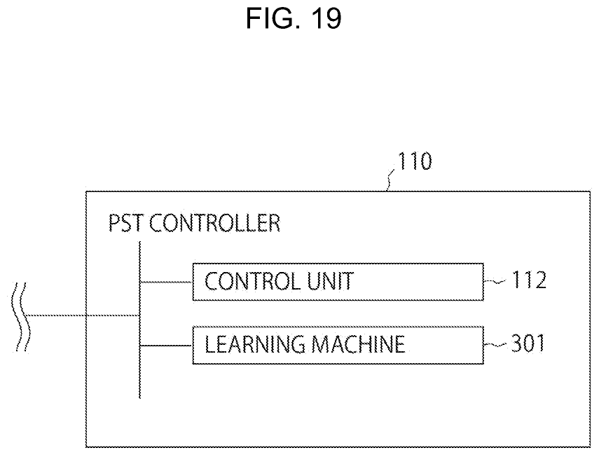

FIG. 19 is a diagram for explaining a step of learning how to select web content according to the engagement score.

A learning machine 301 is implemented in the PST controller 110 illustrated in FIGS. 4 and 19. A program is installed in the learning machine 301, and the learning machine 301 can cooperate with the control unit 112 of the PST controller 110 to change which combination of files is to be adopted according to the type of each file from among the group of files usable in the display environment of the user terminal 101.

The adopted combination of files is selected from the plurality of pieces of web content 211 with different display completion times that can be displayed respectively on each user terminal 101.

For example, it is possible to change which files are selected from among the plurality of files including the HTML file 113 and the processed HTML files 131, and which files are selected from among the respective pluralities of files including the CSS file 107 and the processed CSS files 132, the script language file 108 and the processed script language files 133, and the image file 109 and the processed image files 134.

Within a combination of respective files, each coefficient ai (where i=1, 2, . . . , k, and k is the total number of the history data) of Expression (A) is associated with a single web page.

Note that the coefficients ai are numerical values that serves as an indication of which history data is important.

The values of the coefficients ai are adjusted from the standpoint of maximizing the total time spent viewing the web content 211 and also maximizing the total number of actions such as scrolling, clicking, tapping, and dragging performed by the user.

For example, if users who have clicked the link 302 associated with the web content 211 and viewed the content at the link destination a large number of times 303 have a tendency of spending a longer total time viewing the web content 211 and also performing a greater total number of actions such as clicking and scrolling, the value of the coefficient ai corresponding to the history data about clicking the link 302 increases relatively.

Conversely, if the number of times 303 that users click the link 302 associated with the web content 211 and view the content at the link destination is not found to have a correlation with the total length of time spent viewing the web content 211 or the total number of times the users perform actions such as scrolling, clicking, tapping, or dragging, the value of the coefficient ai corresponding to the history data about clicking the link 302 decreases relatively.

Similarly, the coefficients ai are determined with respect to each type of history data.

Thereafter, the combination of files is changed, and the web content 211 is published to the users for a certain period.

Next, the combination of files is changed to a different combination, and the operation of publishing the web content 211 to the users for a certain period is repeated. In this case, the combination of coefficients ai uniquely corresponding to the combination of files also changes.

Combinations of the obtained values related to Expression (A) and the selected files are recorded in the database 106 of FIG. 4, for example. The above combinations are also recorded in the user terminal 101.

With this arrangement, the execution order and the execution timing corresponding to each of the portion of the web content displayed first on the screen of the user terminal, the time until the portion of the web content displayed first on the screen of the user terminal, and the portions of the web content other than the portion displayed first on the screen of the user terminal can be changed from among the plurality of pieces of web content with different display completion times selected as the web content 211 for each user terminal 101 at regular intervals, and the changes in the engagement score can be recorded in at least one of the user terminal 101 and the web server 103.

In addition, at each time point when the engagement score is measured, a relative value of the engagement score for each user is calculated by treating the value for the user terminal 101 having the highest score in Expression (A) as a relative value of 100.

A step of repeatedly performing the step of searching for combinations such that the relative values of Expression (A) approach 100 for all users viewing the web content 211, or in other words a step of training the learning machine 301, can be performed.

This arrangement makes it possible to automatically learn which combinations of original data and processed data forming the web content maximize the time spent viewing the web content by all users and the number of actions performed on the web content by all users from among the plurality of pieces of web content 211 with different display completion times.

By repeating the operation of monitoring user behavior at regular intervals while changing the combination of files so as to maximize the total time spent viewing the web content 211 by all users and also maximize the total number of actions such as clicking and scrolling performed by all users, the engagement score that maximizes the user experience for each user can be increased.

[Backing Up Data]

As described above, the storage device 1101 in the web server 103 may also be provided with a time execution control unit 120.

In accordance with the execution program 122 saved in the time execution storage unit 121 connected to the time execution control unit 120, after a certain time elapses, backup data of the data and programs necessary to perform the automatic display control method for web content according to Embodiment 1 of the present invention, such as the original data 200 and the processed data 201, 202 for example, is copied and saved in the time execution storage unit 121.

Also, after a certain time elapses, the oldest data for which a certain period has elapsed from among the backup data is removed, for example.

The backup data saved in the time execution storage unit 121 may also be transferred to an external storage device separate from the web server 103 over the network 102 and saved.

[Step of Displaying Web Content Corresponding to Engagement Score on User Terminal]

When the control unit 112 of the PST controller 110 specifies web content 211 that is displayable on the user terminal 101, the web content 211 is transmitted from the web server 103 over the network 102 and received by the user terminal 101.

The received web content 211 is displayed in the browser of the user terminal 101.

In the disclosure of the present invention, optimized data refers to data for displaying web content associated with the engagement score on each user terminal 101.

Also, if the original data 200 is altered, the altered portion of the original data 200 is specified, and the processed data 202 corresponding to the altered portion is generated.

Additionally, if the processed data 201 contains a portion corresponding to the altered portion of the original data 200, the portion is replaced with the processed data 202.

As another example, in the case where all of the original data 200 is altered, all of the processed data 201 is replaced with the processed data 202.

Next, if the control unit 112 of the PST controller 110 specifies the processed data 201 including the processed data 202 displayable on the user terminal 101, the processed data 201 including the processed data 202 is transmitted from the web server 103 over the network 102 and received by the user terminal 101.

The received processed data 201 including the processed data 202 is displayed in the browser of the user terminal 101.

Similarly, in the case where all of the original data 200 is altered, the processed data 202 displayable on the user terminal 101 is transmitted by the control unit 112 of the PST controller 110 from the web server 103 over the network 102 and received by the user terminal 101.

The received processed data 202 is displayed in the browser of the user terminal 101.

Also, if the original data 200 is subjected to an alteration such as a modification, addition, or removal, every time the web server 103 receives a request from the user terminal 101, data including updated web content 212 from among the web content 211 is transmitted to the user terminal 101 from the web server 103 controlled by the control unit 112 of the PST controller 110.

For example, in the case where all of the original data 200 is altered, all of the web content 211 is replaced with the updated web content 212.

At the user terminal 101, the web content 211 including the updated web content 212 can be displayed.

According to the above series of steps, the user terminal 101 receiving the updated web content 212 transmitted from the web server 103 can display the updated web content 212 in the browser installed in the user terminal 101 quickly from the first time.

In the disclosure of the present invention, it is also possible to deliver original content obtained from the unmodified original data 200. Since a DNS change or the like is not necessary to deliver the original content, it is possible to switch between web content corresponding to the engagement score and the original content immediately for the user terminal 101.

### Embodiment 2

Next, an automatic display control method for web content according to Embodiment 2 of the present invention will be described.

The steps necessary for achieving the automatic display control method for web content according to Embodiment 2 are similar to the case of Embodiment 1 of the present invention described above.

Hereinafter, the differences from Embodiment 1 above will be described primarily.

In Embodiment 2 of the present invention, a smartphone is adopted as one example of the user terminal 101. The step of generating the web content 211 described below is similar to the case of Embodiment 1 of the present invention.

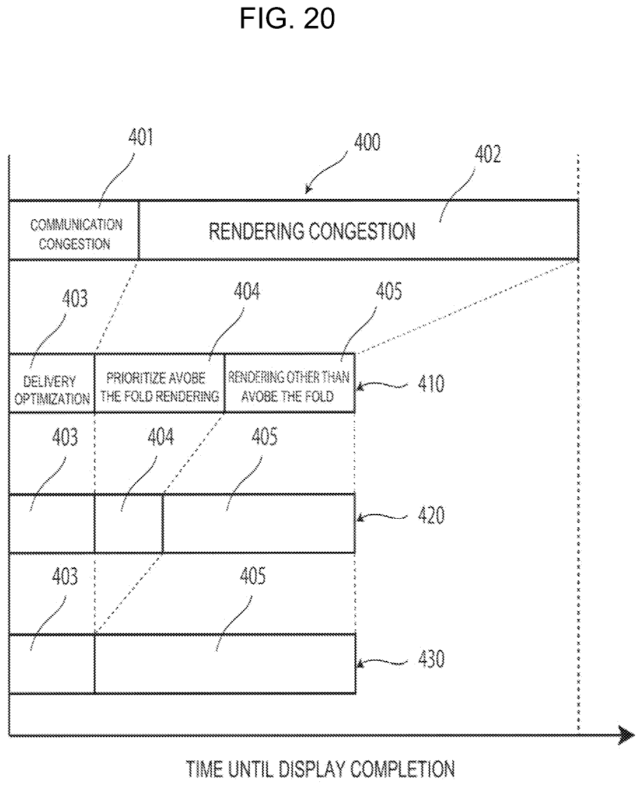

FIG. 20 is a conceptual diagram for explaining a mechanism by which web content 211 is displayed quickly on the user terminal 101.

In general, there are two factors that impede the fast display of the web content 211 on the user terminal 101.

One factor is communication congestion 401, and the other factor is rendering congestion 402.

Ordinarily, the original data 200 (reference sign 400 in FIG. 20) also contains data that is unnecessary depending on the individual user terminal 101. For this reason, if the original data 200 is transmitted to the user terminal 101 as-is, it will take extra time to complete the transmission of the original data to the user terminal 101.

The case of Embodiment 1 above mainly relates to delivery optimization (reference sign 403 in FIG. 20) for improving the communication congestion 401 in FIG. 20.

The case of Embodiment 2 addresses rendering congestion 402 in addition to communication congestion 401.

In the disclosure of the present invention, rendering refers to displaying the web content 211 and the like on the user terminal 101.

One reason why the rendering congestion 401 illustrated in FIG. 20 occurs is that an attempt is made to transmit a large amount of miscellaneous information from the web server 103 to the user terminal 101 all at once.

In the case of Embodiment 2 according to the present invention, the rendering of the portion corresponding to above the fold is prioritized as the information to be transmitted first to the user terminal 101 from the portion of the web content 211 (reference sign 404 in FIG. 20).

Next, communication is regulated to prioritize the transition to a state enabling the user terminal 101 to accept input from the user (reference sign 404 in FIG. 20).

Next, communication is regulated such that the portions of the web content 211 other than the portion corresponding to above the fold is organized and transmitted to the user terminal 101 (reference sign 405 in FIG. 20).

Here, transitioning to a state enabling the user terminal 101 to accept input from the user refers to reaching a state in which the user terminal 101 can accept screen operations such as scrolling, tapping, clicking, and dragging, and input operations such as inputting various text, inputting sound, and inputting images performed by the user.

Also, organizing and transmitting the portions of the web content 211 other than the portion corresponding to above the fold to the user terminal 101 means performing an action like the following in the case where there are two or more program code portions necessary for rendering the portions other than the portion corresponding to above the fold. If the program code portions interfere with each other, synchronous execution is performed such that one of the code portions is prioritized and the execution of the next program code portion proceeds after waiting for the completion of the prioritized program code portion. If the program code portions do not interfere with each other, asynchronous execution is performed such that the execution of one program code portion is started without waiting for the completion of the other program code portion.

Next, Embodiment 2 according to the present invention will be described in detail.

When a request is transmitted from the browser installed in the user terminal 101 to the web server 103, optimized data generated by Embodiment 1 of the present invention described above, namely data optimized according to the engagement score corresponding to the web content 211 that is displayable in the specified display environment of the user terminal 101, is transmitted from the web server 103 receiving the request to the user terminal 101 over the network 102.

At this time, optimized data according to the engagement score is not transmitted to the user terminal 101 for all of the web content 211, but rather the web content 211 is divided so that only the web content 211a referred to as above the fold corresponding to an initial display screen A in the browser of the user terminal 101 is transmitted first.

[Step of Specifying Data Corresponding to Initial Display Screen of User Terminal 101]

The display environment of each user terminal 101 can be specified by cross-checking information such as an accept header or a cookie transmitted from the user terminal 101 to the web server 103 with the model information file 126.

In actuality, preliminary tests can be performed in advance to determine which portion of the web content corresponds to above the fold for each user terminal 101.

The display environment of the initial display screen A in the browser of the user terminal 101 can be specified on the basis of the information written in the model information file 126.

Which portions of the HTML file 113, the CSS file 107, the script language file 108, the processed HTML files 131, the processed CSS files 132, the processed script language files 133, the image file 109, the processed image files 134, and the like are displayed on the initial display screen A corresponding to above the fold in the browser of the user terminal 101 are specified from information about the text data such as letters, numerals, and symbols written in the HTML file 113 and the processed HTML files 131, information about properties such as the size of the text data and information about properties such as the size and layout of the image file 109 and the processed image files 134 written in the CSS file 107 and the processed CSS files 132 described above with reference to FIG. 5.

When the display environment of the user terminal 101 is specified, the HTML file 113, the CSS file 107, the script language file 108, the processed HTML files 131, the processed CSS files 132, the processed script language files 133, the image file 109, the processed image files 134, and the like respectively corresponding to above the fold that can be displayed using the display environment are specified.

The above information is specified by a program written in the control unit 112 of the PST controller 110 installed in the web server 103.

[Step of Specifying Data Corresponding to Portions Other than Initial Display Screen of User Terminal]

If the data to be displayed on the initial display screen A in the browser of the user terminal 101 is specified, the data corresponding to the portions other than the initial display screen A corresponding to the above the fold of the user terminal 101 can be specified accordingly.

The data excluding the data to be displayed on the initial display screen A in the browser of the user terminal 101 from among the web content including at least one selected from the group consisting of the web content 211, the web content 211 including the updated web content 212 and the updated web content 212 is the data corresponding to the portions other than the initial display screen A of the user terminal 101.

The above will be described in terms of a specific example.

For instance, the web content 211 includes web content 211a that corresponds to above the fold and web content 211b that does not correspond to above the fold.

The web content 211 includes HTML data 301 corresponding to above the fold in the HTML file 113 or the processed HTML files 131.

In the disclosure of the present invention, reference information with respect to resources can be replaced with objects in the processed HTML files 131.

This is because the processed HTML files 131 in which all reference information has been replaced with program objects does not take time to download to the user terminal 101.

If the processed HTML files 131 in which all reference information has been replaced with program objects are downloaded to the user terminal 101, the target to be referenced as a program object can be selected freely.

Also, the web content 211 includes CSS data 302 corresponding to above the fold in the CSS file 107 and the processed CSS files 132.

For example, script language data 303 corresponding to above the fold is included in the script language file 108 and the processed script language files 133.

Image data 304 corresponding to above the fold is included in the image file 109 and the processed image files 134.

The user terminal 101 receiving the web content 211a corresponding to above the fold of the user terminal 101 can display the web content 211a in a short display completion time in the browser installed in the user terminal 101.

Next, from among the web content 211b not corresponding to above the fold, the code portion for enabling the user terminal 101 to accept input from the user is prioritized and transmitted to the user terminal 101 (reference sign 404 in FIG. 20).

In the case of Embodiment 2 according to the present invention, after the portion displayed first on the screen of the user terminal 101 is transmitted to the user terminal 101, the time for prioritizing the enabling of the user terminal 101 to accept input (reference sign 404 in FIG. 20) changes according to the engagement score.

In the case of a minimum engagement score, or in other words, in the case such as a user who has never viewed the web content 211 before (reference sign 410 in FIG. 20), the time until the user terminal 101 is ready to accept input is maximally secured, and the transmission of data other than the code portions enabling the user terminal 101 to accept input is blocked.

The above is performed to maximally prioritize the process until the user terminal 101 is ready to accept input following the display of the above the fold.

In the case of an intermediate engagement score, or in other words, in the case of a user who has viewed the web content 211 in moderation (reference sign 420 in FIG. 20), the time for prioritizing the enabling of the user terminal 101 to accept input is shortened. Additionally, the transmission of the web content 211b not corresponding to above the fold to the user terminal 101 is started in parallel, before the user terminal 101 is fully ready to accept input.

In the case of a maximum engagement score, or in other words, in the case of a user who views the web content 211 the most (reference sign 430 in FIG. 20), a time for prioritizing the enabling of the user terminal 101 to accept input is not provided, and the transmission of the web content 211b not corresponding with above the fold to the user terminal 101 is started from the beginning in parallel with or after the user terminal 101 transitions to the state of being ready to accept input.

Next, the steps after the web content 211a corresponding to above the fold is displayed on the user terminal 101 will be described by following user actions.

In the case where the user of the user terminal 101 expresses interest in the web content 211a displayed in the browser of the user terminal 101, the user performs an action causing the browser of the user terminal 101 to display additional information.

Conversely, in the case where the user of the user terminal 101 does not express interest in the web content 211a displayed in the browser of the user terminal 101, the user performs the action also referred to as bouncing.

Specific examples of the case where the user performs an action causing the browser of the user terminal 101 to display additional information when the user of the user terminal 101 expresses interest in the web content 211a corresponding to above the fold displayed in the browser of the user terminal 101 are as follows.

For example, the user of the user terminal 101 performs an action such as clicking a button or the like displayed in the browser of the user terminal 101, scrolling the browser of the user terminal 101 to see information that will be displayed by scrolling the initial display screen A in the browser of the user terminal 101, or continuing to read the displayed content without bouncing from the initial display screen A even though a certain time has elapsed since the initial display screen A was displayed in the browser of the user terminal 101.

When the user performs an action such as clicking or scrolling with respect to the user terminal 101, the browser installed in the user terminal 101 detects event information. Thereafter, signals corresponding to event information indicating actions are transmitted from the user terminal 101 to the web server 103 over the network 102.

According to an instruction from the control unit 112 of the PST controller 110 installed in the web server 103 detecting these signals, the resources for displaying the remaining web content 211b are immediately transmitted to the user terminal 101 over the network 102.

The user terminal 101 receiving the web content 211b can display the web content 211b quickly in the browser installed in the user terminal 101.

With this arrangement, user bounce can be prevented. Note that the resources for displaying the web content 211b may be transmitted to the user terminal 101 all at once, or the resources may be split up and transmitted.

In the transmission of the web content 211b, if program code portions related to the display of the web content 211b on the user terminal 101 interfere with each other, the program code portions are executed synchronously such that after the execution of one program code portion is completed, the next program code portion is started.

Conversely, if program code portions related to the display of the web content 211b on the user terminal 101 do not interfere with each other, the respective program code portions are started asynchronously.

Also, execution control such as which program to prioritize or delay is controlled by a program written in the control unit 112 of the PST controller 110 installed in the web server 103.

On the other hand, for users having an engagement score of a certain value or higher, after only the web content 211a corresponding to the initial display screen A in the browser of the user terminal 101 is first transmitted separately, all of the remaining web content 211b is transmitted to the user terminal 101 without prioritizing the process for enabling the user terminal 101 to accept input.

For users having a certain engagement score or higher, the preparations for displaying the web content 211b can be advanced without delay, thereby increasing user satisfaction.

### Embodiment 3

Next, an automatic display control method for web content according to Embodiment 3 of the present invention will be described.

The steps necessary for achieving the automatic display control method for web content according to Embodiment 3 are similar to the case of Embodiment 2 of the present invention described above.

Hereinafter, the differences from Embodiment 2 above will be described primarily.

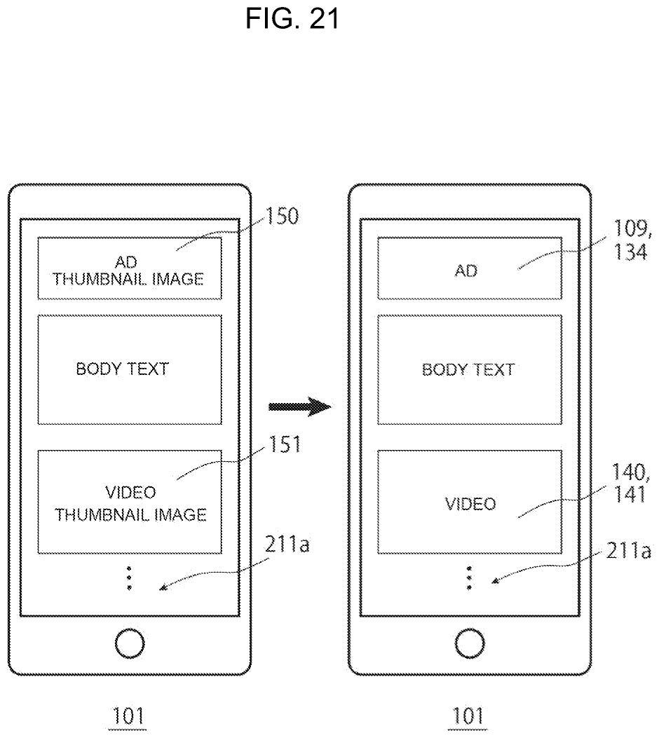

FIG. 21 is a schematic diagram for explaining a display and a change of thumbnail images on an initial display screen of a user terminal.

For users having an engagement score of a certain value or less, the web content 211a is displayed first as above the fold similarly to the case of Embodiment 2 of the present invention on the initial display screen A in the browser of each user terminal 101.

The web content 211 displayed on the browser of each user terminal 101 includes one or more types of data such as an image file 109 for displaying ad content, processed image files 134 for displaying ad content, a video file 140, and processed video files 141, for example.

For each of the one or more types of data such as the image file 109 for displaying ad content, the processed image files 134 for displaying ad content, the video file 140, and the processed video files 141, the combination with the shortest overall display completion time from among the data with different display sizes, data sizes, and data types is included in the web content 211.

For example, an ad content thumbnail image 150 is generated for the image file actually included in the web content 211a from among the image file 109 for displaying ad content and the processed image files 134 for displaying ad content included in the web content 211.

Similarly, for example, a video thumbnail image 151 is generated for the video file actually included in the web content 211a from among the video file 140 and the processed video files 141.

The ad content thumbnail image 150 is a copy of only the image actually displayed in the browser of the user terminal 101 from among the image file 109 for displaying ad content or the processed image files 134 for displaying ad content displayed in the browser of the user terminal 101, and is also referred to as a captured image.

The image with the smallest data size from among the captured images is adopted as the ad content thumbnail image 150.

The ad content thumbnail image 150 is merely an image, and the image is simply displayed in the browser of the user terminal 101. Even if the image is actually clicked, nothing happens.

Likewise, the video thumbnail image 151 is a copy of an image referred to as a captured image of the video file 140 or the processed video files 141 displayed in the browser of the user terminal 101.

The image with the smallest data size from among the captured images is adopted as the video thumbnail image 151.

The video thumbnail image 151 is merely an image, and the image is simply displayed in the browser of the user terminal 101. Like the above case, nothing happens even if the image is actually clicked.

The ad content thumbnail image 150 can be displayed on the user terminal 101 with a simpler process than the image file 109 for displaying ad content and the processed image files 134 for displaying ad content, and consequently the ad content thumbnail image 150 can be displayed in the browser of the user terminal 101 in a shorter time than the display completion time of the image file for displaying ad content or the processed image files 134 for displaying ad content.

Similarly, the video thumbnail image 151 can be displayed on the user terminal 101 with a simpler process than the video file 140 and the processed video files 141, and consequently the display of the video thumbnail image 151 in the browser of the user terminal 101 can be completed more quickly than the video file 140 or the processed video files 141.

It is possible to determine whether or not the user is interested in the informational content of the web content 211a displayed in the browser of the user terminal 101 according to actions such as whether the user bounces from the currently displayed page in the browser, whether the user continues to read the informational content of the web content 211a, scrolls the browser of the user terminal 101, clicks on the ad content thumbnail image 150, or clicks on the video thumbnail image 151.

In the case where the user bounces from the content currently displayed in the browser, it is not necessary to transmit additional information from the web server 103 to the user terminal 101.

Conversely, in the case where the user does not bounce from the content currently displayed in the browser, and a certain time has elapsed since the completion of the display of the web content 211a in the browser of the user terminal 101, for example, it is inferred that the user is continuing to read the content of the web content 211a.

In the case of Embodiment 3, it is inferred that the user is reading the content of the web content 211a if five seconds have elapsed since the completion of the display of the web content 211a in the browser of the user terminal 101, for example.

In the case where the user does not bounce from the browser but also does not perform a proactive operation such as clicking or scrolling in the browser of the user terminal 101, after a certain time elapses, the image file with the shortest display completion time from among the image file for displaying ad content or the processed image files 134 for displaying ad content is transmitted from the web server 103 to the user terminal 101 over the network 102.

The certain time above to be set is set appropriately depending on factors such as the type of user terminal 101 and the content of the information displayed in above the fold, but ordinarily is in the range of 1-10 seconds.

When the image file with the shortest display completion time from among the image file 109 for displaying ad content and the processed image files 134 for displaying ad content is received by the user terminal 101, the ad content thumbnail image 150 displayed previously is replaced with the file with the shortest display completion time.

If the image file with the shortest display completion time from among the image files containing ad information includes a link or script language for displaying ad information, and the user clicks on the image file with the short display completion time, the ad information saved in an external server different from the designated domain can be referenced over the network 102.

Similarly, in the case where the user does not perform a proactive operation such as clicking or scrolling in the browser of the user terminal 101, after a certain time elapses, the video file with the shortest display completion time from among the video file 140 and the processed video files 141 is transmitted from the web server 103 to the user terminal 101 over the network 102.

When the video file with the shortest display completion time from among the video file 140 or processed video files 141 is received by the user terminal 101, the video thumbnail image 151 displayed previously is replaced with the video file with the short display completion time.

If the video file with the shortest display completion time from among the video files containing ad information includes a script language for displaying a video, and the user clicks on the video file with the shortest display completion time, video information can be referenced over the network 102 by playing back a video including sound saved in an external server different from the designated domain.

On the other hand, if the user performs actions such as clicking or scrolling the browser of the user terminal 101, signals related to event information corresponding to the actions are transmitted from the browser of the user terminal 101 to the web server 103 over the network 102.

The web server 103 receiving these signals transmits the image file with the shortest display completion time from among the image file for displaying ad content or processed image files 134 for displaying ad content and the video file with the shortest display completion time from among the video file 140 and the processed video files 141 immediately from the storage device 1101, for example.

The remaining the web content 211b is also transmitted to the user terminal 101 over the network 102.

The user terminal 101 receiving the above data can display the image file with the shortest display completion time, the video file with the shortest display completion time, and the web content 211b quickly in the browser installed in the user terminal 101.

In the case of the automatic display control method for web content according to Embodiment 3 of the present invention, the ad content thumbnail image 150 and the video thumbnail image 151 are respectively used first instead of an image file with a short display completion time and a video file with a short display completion time related to the display of above the fold in the browser of the user terminal 101.

In the case of the technology of the related art, preparations for displaying an ad and playing back a video on the user terminal 101 are started irrespectively of whether or not the user clicks on the image file for displaying ad content or clicks on the video file 140.

In contrast, in the case of the automatic display control method for web content according to Embodiment 3 of the present invention, if the user does not express interest in the informational content of the web content 211a displayed in the browser of the user terminal 101, provisional information, namely the ad content thumbnail image 150, the video thumbnail image 151, and the like, is displayed in above the fold of the user terminal 101.

The display completion time for the provisional information can be shortened, and consequently the time of information transfer from the web server 103 to the user terminal 101 can be reduced, thereby preventing bounce by users with a low engagement score.

Also, in the case where the user expresses interest in the informational content of the web content 211a displayed in the browser of the user terminal 101, preparations for displaying an ad and playing back a video can be started while the user is reading the informational content displayed in the browser of the user terminal 101 according to the web content 211a.

Also, in the case where the user performs an action indicating a desire to display more informational content of the web content 211a, such as clicking, tapping, or scrolling the browser of the user terminal 101, event information about the clicking, tapping, or scrolling can be detected as a signal in at least one of the web server 103 and the browser of the user terminal 101, and therefore preparations on the web server 103 side for downloading and displaying an ad or playing back a video in the user terminal 101 can be started immediately with respect to resources related to displaying the ad or playing back the video.

As described above, in the case of the automatic display control method for web content according to Embodiment 3 of the present invention, an automatic display control method for web content can be achieved on the basis of the user experience.

Conversely, for users having an engagement score of a certain value or more, all of the web content 211 is transmitted to the user terminal 101. The preparations for displaying an ad or playing back a video in the user terminal 101 are started from the beginning, and consequently users having an engagement score of a certain value or more can utilize the ad display, video playback, and the like at an early stage.

### INDUSTRIAL APPLICABILITY

The automatic display control method for web content is capable of resolving the conflicting intentions between a user who view web content displayed on a web site and an operator of the web site, and therefore is widely applicable to the communication field that deals with web content using a network.

### REFERENCE SIGNS LIST

101 user terminal
102 network
103 web server
104 original data storage area
105 PHP file
106 database
107 CSS file
107a, b, c CSS code portion
107x, 108x, 113x portion not used by user terminal
F107a to F107c, F108a to F108c object
108 script language file
108a to 108d script language code portion
109 image file
110 PST controller
111 PST plugin
112 control unit
113 HTML file
113a to 113d HTML code portion
115 monitoring control unit
116 operation control unit
117 operation control storage unit
120 time execution control unit
121 time execution storage unit
122 execution program
123 settings file storage unit
124 resource file
125 settings file
126 model information file
130 processed data storage area
131 processed HTML files
132 processed CSS file
133 processed script language file
134 processed image file
140 video file
141 processed video file
150 ad content thumbnail image
151 video thumbnail image
200 original data
201, 202 processed data
203 CLI
211, 212 web content
211a web content for above the fold
211b web content for other than above the fold
301 learning machine
401 communication congestion
402 rendering congestion
403 delivery optimization
404 rendering of portion corresponding to above the fold
405 rendering of portions other than portion corresponding to above the fold
410 case of minimum engagement score
420 case of intermediate engagement score
430 case of maximum engagement score
1000, 1100 central processing unit
1001, 1101 storage device
1001a, 1101a main storage unit
1001b, 1101b auxiliary storage unit
1002, 1102 communication interface
1003, 1103 input device
1004, 1104 display device
1105 OS

1-16. (canceled)

17. An automatic display control method for web content in which data saved in a storage area usable by a web server is displayed on a user terminal over a network, the method comprising:
a step of generating a plurality of processed data by processing original data saved in the storage area usable by the web server;
a step of calculating an engagement score between a user and the web content on the basis of a user experience of the user viewing the web content; and
a step of selecting optimized data displayable on each user terminal from at least one resource selected from the group consisting of the original data and the plurality of processed data according to the engagement score,
the above steps being performed at least one of before the web server receives a request from the user terminal and immediately after the web server receives the request from the user terminal; and
a step of displaying the web content to be displayed on each user terminal according to the generated optimized data from a first time that the request is transmitted from the user terminal to the web server, wherein
the at least one resource selected from the group consisting of the original data and the plurality of processed data includes at least one of program data and binary data,
the program data includes a program containing at least one selected from the group consisting of a markup language, a programming language, a style sheet, and a script language,
the binary data includes at least one file selected from the group consisting of an image file, an audio file, and a video file, and
the step of generating a plurality of processed data by processing original data saved in the storage area usable by the web server comprises:
a step of respectively specifying a program code portion to be executed and a program portion not to be executed from the program containing at least one selected from the group consisting of a markup language, a programming language, a style sheet, and a script language, and extracting a plurality of specified program code portions to be executed;
a step of determining an execution order of the program code portions to be executed with priority and the program code portions to be executed with a delay among the plurality of specified program code portions to be executed;
a step of determining an execution timing of the program code portions to be executed with priority and the program code portions to be executed with a delay among the plurality of specified program code portions to be executed; and
a step of changing one selected from the group consisting of a number of display pixels per unit area, an image or sound recording density per unit time, a data size, and a save format of at least one file among the image file, the audio file, and the video file.

18. The automatic display control method for web content according to claim 17, wherein
the step of selecting optimized data displayable on each user terminal from at least one resource selected from the group consisting of the original data and the plurality of processed data according to the engagement score comprises:
a step of selecting two or more of data displayable on each user terminal from among resources selected from the group consisting of the original data and the plurality of processed data according to the engagement score; and
a step of comparatively ranking the two or more of the data on a basis of a display completion time for each user terminal.

19. The automatic display control method for web content according to claim 17, wherein
the step of displaying the web content on each user terminal comprises:
a step of transmitting, to the user terminal, optimized data corresponding to a portion of the web content to be displayed first on a screen of the user terminal, wherein
after the optimized data corresponding to the portion of the web content to be displayed first on the screen of the user terminal is transmitted to the user terminal, a time for prioritizing a process enabling the user terminal to accept input changes according to the engagement score.

20. The automatic display control method for web content according to claim 17, wherein
the step of selecting optimized data displayable on each user terminal from at least one resource selected from the group consisting of the original data and the plurality of processed data according to the engagement score comprises:
a step of changing an execution order of programs respectively corresponding to
a data portion of the web content displayed first on a screen of the user terminal,
a time until the user terminal accepts input with respect to the portion of the web content displayed first on the screen of the user terminal, and
a data portion other than the data portion of the web content displayed first on the screen of the user terminal
and also, a step of changing an execution timing of programs respectively corresponding to
a data portion of the web content displayed first on a screen of the user terminal,
a time until the user terminal accepts input with respect to the portion of the web content displayed first on the screen of the user terminal, and
a data portion other than the data portion of the web content displayed first on the screen of the user terminal
with respect to data for displaying web content selected for each user terminal from among data for displaying a plurality of pieces of web content with different display completion times with respect to the user terminal at regular intervals, and recording a change in the engagement score; and
a step of learning which combinations of original data and the plurality of processed data forming the web content maximize the time spent viewing the web content by all users and the number of actions performed on the web content by all users from among the plurality of pieces of web content with different display completion times with respect to the user terminal.
